(19) United States
(12) Patent Application Publication
(10) Pub. No.: US 2024/0098163 A1
(43) Pub. Date: Mar. 21, 2024

(54) FOLDABLE ELECTRONIC DEVICE INCLUDING SHAPE MEMORY ALLOY AND CONTROLLING METHOD THEREFOR

(71) Applicant: Samsung Electronics Co., Ltd., Suwon-si (KR)

(72) Inventors: Baekeun CHO, Suwon-si (KR); Myunghoon KWAK, Suwon-si Gyeonggi-do (KR); Bohyeon KIM, Suwon-si Gyeonggi-do (KR); Moonsun KIM, Suwon-si (KR); Jookwan LEE, Suwon-si (KR); Hyoungtak CHO, Suwon-si (KR); Soyoung LEE, Suwon-si (KR); Yangwook KIM, Suwon-si (KR); Junghyeob LEE, Suwon-si (KR)

(21) Appl. No.: 18/521,358

(22) Filed: Nov. 28, 2023

Related U.S. Application Data
(63) Continuation of application No. PCT/KR2022/095138, filed on Oct. 19, 2022.

(30) Foreign Application Priority Data
Oct. 20, 2021 (KR) 10-2021-0140546

(51) Int. Cl. H04M 1/02

(52) U.S. Cl. CPC H04M 1/0216; H04M 1/0266; H04M 2250/12

(57) ABSTRACT

An electronic device may include a first housing, a second housing, a hinge device configured to connect the first housing and the second housing so that the electronic device is switched from a folded state into an unfolded state, a first alloy member, at least a part of which is fixed to the first housing, the second housing, and the hinge device and which is made of a shape memory alloy material, a second alloy device, at least a part of which is fixed to the first housing and the second housing at a position different from the first alloy member and which is made of a shape memory alloy material, and a driving circuit configured to apply power to at least one of the first alloy member and the second alloy member so that at least one of the first alloy member and the second alloy member is restored. Various other embodiments may be possible.

### CROSS-REFERENCE TO RELATED APPLICATIONS

This application is a continuation of International Application No. PCT/KR2022/095138, designating the United States, filed on Oct. 19, 2022, in the Korean Intellectual Property Receiving Office, and claiming priority to KR Patent Application No. 10-2021-0140546 filed on Oct. 20, 2021, in the Korean Intellectual Property Office, the disclosures of all of which are hereby incorporated by reference herein in their entireties.

### BACKGROUND

### Field

Various example embodiments relate to a foldable electronic device including a shape memory alloy, and/or a method for controlling the same.

### DESCRIPTION OF RELATED ART

As electronic devices visually display more information and support more functions, users who want displays having larger screens are increasing. There has been development of a new type of electronic devices for providing displays having large screens while maintaining portable sizes.

Development of display technologies has made it possible to implement foldable displays. Electronic devices using such displays such that the information display area can be varied by folding are also available.

Foldable electronic devices including foldable displays may have increased portability in a folded state, and may have an increased information display area in an unfolded state. Accordingly, new device use environments may be provided to users.

### SUMMARY

A foldable electronic device may be folded or unfolded by an external force provided by the user. The force necessary in the process of unfolding or folding the electronic device may be increased by the structural stability of the foldable electronic device and the force for maintaining the folded state while no external force is provided.

The increased force necessary to fold or unfold the foldable electronic device may be a burden on the user. For this reason, some users may use the electronic device held in the same state (for example, folded state or unfolded state).

This may have a disadvantageous effect when the user wants to use the new device use environment provided by the foldable electronic device.

Various example embodiments disclosed herein may provide various structures capable of assisting folding and unfolding operations of a foldable electronic device by using a shape memory alloy which memories a specific shape.

An electronic device according to various example embodiments may include a first housing, a second housing, a hinge device configured to connect the first housing and the second housing such that the electronic device is switched from a folded state into an unfolded state, a first alloy member, at least a part of which is fixed to the first housing, the second housing, and the hinge device and which is made of a shape memory alloy material, a second alloy member, at least a part of which is fixed to the first housing and the second housing at a position different from the first alloy member and which is made of a shape memory alloy material, and a driving circuit configured to apply power to at least one of the first alloy member and the second alloy member such that at least one of the first alloy member and the second alloy member is restored.

A method of controlling an electronic device according to various example embodiments may include identifying, by at least one processor, separation of a first magnet in a first housing and a second magnet disposed in a second housing foldably connected, directly or indirectly, to the first housing detected using a least a hall sensor or a motion sensor, controlling, by the at least one processor, a driving circuit, such that at least a part thereof is fixed to the first housing and the second housing and power is applied to an alloy member made of a shape memory alloy material restored to a predetermined shape, based on the identification, identifying, by the at least one processor, a folded state of the first housing and the second housing detected using at least a folding sensor, and controlling, by the at least one processor, the driving circuit such that the power application to the alloy member is stopped, based on arrival of the folded state at a predetermined state.

According to various example embodiments, a shape memory alloy may be used such that unfolding or folding operations of an electronic device are performed automatically, or the unfolding or folding operations are assisted, thereby reducing the force necessary therefor.

Accordingly, user convenience may be improved, and the user may thus freely unfold or fold the electronic device, thereby conveniently using user experience provided by the foldable electronic device.

### BRIEF DESCRIPTION OF DRAWINGS

In connection with description of drawings, identical or similar components may be given similar or identical reference numerals.

FIG. 1 is a block diagram of an electronic device within a network environment according to various example embodiments.

FIG. 2A illustrates unfolded states of an electronic device, when viewed from a front surface and a rear surface, according to various example embodiments.

FIG. 2B illustrates folded states of an electronic device, when viewed from a front surface and a rear surface, according to various example embodiments.

FIG. 3 is an exploded perspective view of an electronic device according to various example embodiments.

FIG. 4 is an exploded perspective view of an electronic device according to various example embodiments.

FIG. 5A is a plan view of an electronic device according to various example embodiments.

FIG. 5B is a rear view of an electronic device according to various example embodiments.

FIG. 6A is a partial enlarged view of a P1 portion of FIG. 5A.

FIG. 6B is a partial enlarged view of a P2 portion of FIG. 5B.

FIG. 7 and FIG. 8 are views for illustrating a fixing method of an alloy member according to various example embodiments.

FIG. 9 is a view for illustrating an alloy member accommodated in a flexible carrier according to various example embodiments.

FIG. 10 is a graph showing force relating to a folded process of an electronic device according to various example embodiments.

FIGS. 11A, 11B, and 11C are views for illustrating a folded or an unfolded process of an electronic device including an alloy member according to various example embodiments.

FIGS. 12A, 12B, and 12C are views for illustrating a disposition of an alloy member according to various example embodiments.

FIG. 13A and FIG. 13B are views of an electronic device including a plurality of alloy members according to various example embodiments.

FIG. 14 is a schematic view of a circuit for applying power to an alloy member according to various example embodiments.

FIG. 15A is a view of an electronic device including a heat dissipation member according to various example embodiments.

FIG. 15B is a cross-sectional perspective view of FIG. 15A taken along line A-A.

FIG. 16 is a view of an electronic device including a heat dissipation member according to various example embodiments.

FIG. 17 is a perspective view of an electronic device including an alloy member according to various example embodiments.

FIG. 18 and FIG. 19 are flowcharts illustrating a method of controlling an alloy member of an electronic device according to various example embodiments.

FIG. 20AA is a perspective view illustrating a part of an electronic device including an alloy member having a contracting or an expanding wire shape according to various example embodiments.

FIG. 20AB is a cross-sectional view corresponding to the electronic device of FIG. 20AA.

FIG. 20BA is a perspective view illustrating a part of an electronic device including an alloy member having a contracting or an expanding wire shape according to various example embodiments.

FIG. 20BB is a cross-sectional view corresponding to the electronic device of FIG. 20BA.

### DETAILED DESCRIPTION

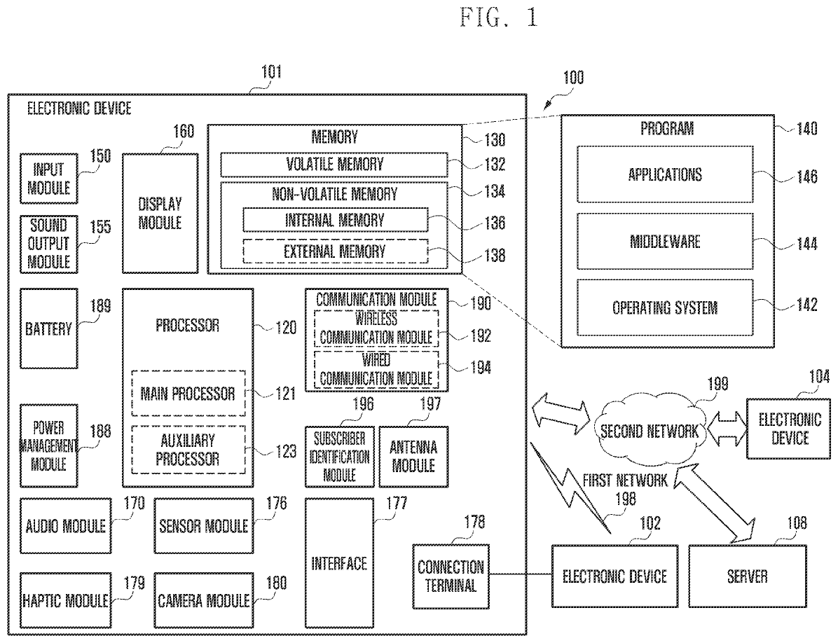

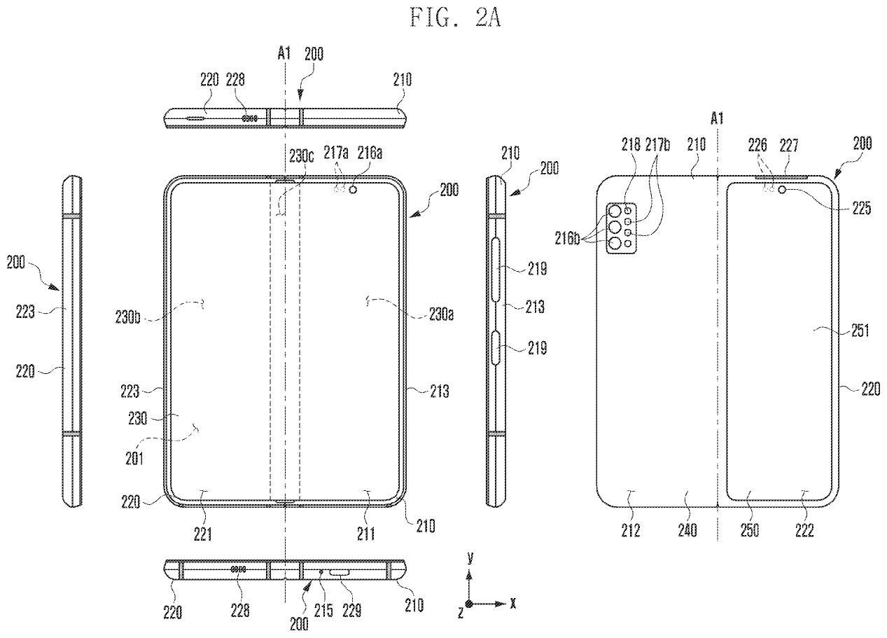

FIG. 1 is a block diagram illustrating an electronic device in a network environment according to various embodiments. Referring to FIG. 1, an electronic device 101 in a network environment 100 may communicate with an electronic device 102 via a first network 198 (e.g., a short-range wireless communication network), or at least one of an electronic device 104 or a server 108 via a second network 199 (e.g., a long-range wireless communication network). According to an embodiment, the electronic device 101 may communicate with the electronic device 104 via the server 108. According to an embodiment, the electronic device 101 may include a processor 120, memory 130, an input module 150, a sound output module 155, a display module 160, an audio module 170, a sensor module 176, an interface 177, a connecting terminal 178, a haptic module 179, a camera module 180, a power management module 188, a battery 189, a communication module 190, a subscriber identification module (SIM) 196, or an antenna module 197. In some embodiments, at least one of the components (e.g., the connecting terminal 178) may be omitted from the electronic device 101, or one or more other components may be added in the electronic device 101. In some embodiments, some of the components (e.g., the sensor module 176, the camera module 180, or the antenna module 197) may be implemented as a single component (e.g., the display module 160). Each “module” herein may comprise circuitry.

The processor 120 may execute, for example, software (e.g., a program 140) to control at least one other component (e.g., a hardware or software component) of the electronic device 101 coupled with the processor 120, and may perform various data processing or computation. According to an embodiment, as at least part of the data processing or computation, the processor 120 may store a command or data received from another component (e.g., the sensor module 176 or the communication module 190) in volatile memory 132, process the command or the data stored in the volatile memory 132, and store resulting data in non-volatile memory 134. According to an embodiment, the processor 120 may include a main processor 121 (e.g., a central processing unit (CPU) or an application processor (AP)), or an auxiliary processor 123 (e.g., a graphics processing unit (GPU), a neural processing unit (NPU), an image signal processor (ISP), a sensor hub processor, or a communication processor (CP)) that is operable independently from, or in conjunction with, the main processor 121. For example, when the electronic device 101 includes the main processor 121 and the auxiliary processor 123, the auxiliary processor 123 may be adapted to consume less power than the main processor 121, or to be specific to a specified function. The auxiliary processor 123 may be implemented as separate from, or as part of the main processor 121.

The auxiliary processor 123 may control at least some of functions or states related to at least one component (e.g., the display module 160, the sensor module 176, or the communication module 190) among the components of the electronic device 101, instead of the main processor 121 while the main processor 121 is in an inactive (e.g., sleep) state, or together with the main processor 121 while the main processor 121 is in an active state (e.g., executing an application). According to an embodiment, the auxiliary processor 123 (e.g., an image signal processor or a communication processor) may be implemented as part of another component (e.g., the camera module 180 or the communication module 190) functionally related to the auxiliary processor 123. According to an embodiment, the auxiliary processor 123 (e.g., the neural processing unit) may include a hardware structure specified for artificial intelligence model processing. An artificial intelligence model may be generated by machine learning. Such learning may be performed, e.g., by the electronic device 101 where the artificial intelligence is performed or via a separate server (e.g., the server 108). Learning algorithms may include, but are not limited to, e.g., supervised learning, unsupervised learning, semi-supervised learning, or reinforcement learning. The artificial intelligence model may include a plurality of artificial neural network layers. The artificial neural network may be a deep neural network (DNN), a convolutional neural network (CNN), a recurrent neural network (RNN), a restricted boltzmann machine (RBM), a deep belief network (DBN), a bidirectional recurrent deep neural network (BRDNN), deep Q-network or a combination of two or more thereof but is not limited thereto. The artificial intelligence model may, additionally or alternatively, include a software structure other than the hardware structure.

The memory 130 may store various data used by at least one component (e.g., the processor 120 or the sensor module 176) of the electronic device 101. The various data may include, for example, software (e.g., the program 140) and input data or output data for a command related thereto. The memory 130 may include the volatile memory 132 or the non-volatile memory 134.

The program 140 may be stored in the memory 130 as software, and may include, for example, an operating system (OS) 142, middleware 144, or an application 146.

The input module 150 may receive a command or data to be used by another component (e.g., the processor 120) of the electronic device 101, from the outside (e.g., a user) of the electronic device 101. The input module 150 may include, for example, a microphone, a mouse, a keyboard, a key (e.g., a button), or a digital pen (e.g., a stylus pen).

The sound output module 155 may output sound signals to the outside of the electronic device 101. The sound output module 155 may include, for example, a speaker or a receiver. The speaker may be used for general purposes, such as playing multimedia or playing record. The receiver may be used for receiving incoming calls. According to an embodiment, the receiver may be implemented as separate from, or as part of the speaker.

The display module 160 may visually provide information to the outside (e.g., a user) of the electronic device 101. The display module 160 may include, for example, a display, a hologram device, or a projector and control circuitry to control a corresponding one of the display, hologram device, and projector. According to an embodiment, the display module 160 may include a touch sensor adapted to detect a touch, or a pressure sensor adapted to measure the intensity of force incurred by the touch.

The audio module 170 may convert a sound into an electrical signal and vice versa. According to an embodiment, the audio module 170 may obtain the sound via the input module 150, or output the sound via the sound output module 155 or a headphone of an external electronic device (e.g., an electronic device 102) directly (e.g., wiredly) or wirelessly coupled with the electronic device 101.

The sensor module 176 may detect an operational state (e.g., power or temperature) of the electronic device 101 or an environmental state (e.g., a state of a user) external to the electronic device 101, and then generate an electrical signal or data value corresponding to the detected state. According to an embodiment, the sensor module 176 may include, for example, a gesture sensor, a gyro sensor, an atmospheric pressure sensor, a magnetic sensor, an acceleration sensor, a grip sensor, a proximity sensor, a color sensor, an infrared (IR) sensor, a biometric sensor, a temperature sensor, a humidity sensor, or an illuminance sensor.

The interface 177 may support one or more specified protocols to be used for the electronic device 101 to be coupled with the external electronic device (e.g., the electronic device 102) directly (e.g., wiredly) or wirelessly. According to an embodiment, the interface 177 may include, for example, a high definition multimedia interface (HDMI), a universal serial bus (USB) interface, a secure digital (SD) card interface, or an audio interface.

A connecting terminal 178 may include a connector via which the electronic device 101 may be physically connected with the external electronic device (e.g., the electronic device 102). According to an embodiment, the connecting terminal 178 may include, for example, a HDMI connector, a USB connector, a SD card connector, or an audio connector (e.g., a headphone connector).

The haptic module 179 may convert an electrical signal into a mechanical stimulus (e.g., a vibration or a movement) or electrical stimulus which may be recognized by a user via his tactile sensation or kinesthetic sensation. According to an embodiment, the haptic module 179 may include, for example, a motor, a piezoelectric element, or an electric stimulator.

The camera module 180 may capture a still image or moving images. According to an embodiment, the camera module 180 may include one or more lenses, image sensors, image signal processors, or flashes.

The power management module 188 may manage power supplied to the electronic device 101. According to an embodiment, the power management module 188 may be implemented as at least part of, for example, a power management integrated circuit (PMIC).

The battery 189 may supply power to at least one component of the electronic device 101. According to an embodiment, the battery 189 may include, for example, a primary cell which is not rechargeable, a secondary cell which is rechargeable, or a fuel cell.

The communication module 190 may support establishing a direct (e.g., wired) communication channel or a wireless communication channel between the electronic device 101 and the external electronic device (e.g., the electronic device 102, the electronic device 104, or the server 108) and performing communication via the established communication channel. The communication module 190 may include one or more communication processors that are operable independently from the processor 120 (e.g., the application processor (AP)) and supports a direct (e.g., wired) communication or a wireless communication. According to an embodiment, the communication module 190 may include a wireless communication module 192 (e.g., a cellular communication module, a short-range wireless communication module, or a global navigation satellite system (GNSS) communication module) or a wired communication module 194 (e.g., a local area network (LAN) communication module or a power line communication (PLC) module). A corresponding one of these communication modules may communicate with the external electronic device via the first network 198 (e.g., a short-range communication network, such as Bluetooth™, wireless-fidelity (Wi-Fi) direct, or infrared data association (IrDA)) or the second network 199 (e.g., a long-range communication network, such as a legacy cellular network, a 5G network, a next-generation communication network, the Internet, or a computer network (e.g., LAN or wide area network (WAN)). These various types of communication modules may be implemented as a single component (e.g., a single chip), or may be implemented as multi components (e.g., multi chips) separate from each other. The wireless communication module 192 may identify and authenticate the electronic device 101 in a communication network, such as the first network 198 or the second network 199, using subscriber information (e.g., international mobile subscriber identity (IMSI)) stored in the subscriber identification module 196.

The wireless communication module 192 may support a 5G network, after a 4G network, and next-generation communication technology, e.g., new radio (NR) access technology. The NR access technology may support enhanced mobile broadband (eMBB), massive machine type communications (mMTC), or ultra-reliable and low-latency communications (URLLC). The wireless communication module 192 may support a high-frequency band (e.g., the millimeter (mm) Wave band) to achieve, e.g., a high data transmission rate. The wireless communication module 192 may support various technologies for securing performance on a high-frequency band, such as, e.g., beamforming, massive multiple-input and multiple-output (massive MIMO), full dimensional MIMO (FD-MIMO), array antenna, analog beam-forming, or large scale antenna. The wireless communication module 192 may support various requirements specified in the electronic device 101, an external electronic device (e.g., the electronic device 104), or a network system (e.g., the second network 199). According to an embodiment, the wireless communication module 192 may support a peak data rate (e.g., 20 Gbps or more) for implementing eMBB, loss coverage (e.g., 164 dB or less) for implementing mMTC, or U-plane latency (e.g., 0.5 ms or less for each of downlink (DL) and uplink (UL), or a round trip of 1 ms or less) for implementing URLLC.

The antenna module 197 may transmit or receive a signal or power to or from the outside (e.g., the external electronic device) of the electronic device 101. According to an embodiment, the antenna module 197 may include an antenna including a radiating element composed of a conductive material or a conductive pattern formed in or on a substrate (e.g., a printed circuit board (PCB)). According to an embodiment, the antenna module 197 may include a plurality of antennas (e.g., array antennas). In such a case, at least one antenna appropriate for a communication scheme used in the communication network, such as the first network 198 or the second network 199, may be selected, for example, by the communication module 190 (e.g., the wireless communication module 192) from the plurality of antennas. The signal or the power may then be transmitted or received between the communication module 190 and the external electronic device via the selected at least one antenna. According to an embodiment, another component (e.g., a radio frequency integrated circuit (RFIC)) other than the radiating element may be additionally formed as part of the antenna module 197.

According to various embodiments, the antenna module 197 may form a mmWave antenna module. According to an embodiment, the mmWave antenna module may include a printed circuit board, a RFIC disposed on a first surface (e.g., the bottom surface) of the printed circuit board, or adjacent to the first surface and capable of supporting a designated high-frequency band (e.g., the mmWave band), and a plurality of antennas (e.g., array antennas) disposed on a second surface (e.g., the top or a side surface) of the printed circuit board, or adjacent to the second surface and capable of transmitting or receiving signals of the designated high-frequency band.

At least some of the above-described components may be coupled mutually and communicate signals (e.g., commands or data) therebetween via an inter-peripheral communication scheme (e.g., a bus, general purpose input and output (GPIO), serial peripheral interface (SPI), or mobile industry processor interface (MIPI)).

According to an embodiment, commands or data may be transmitted or received between the electronic device 101 and the external electronic device 104 via the server 108 coupled with the second network 199. Each of the electronic devices 102 or 104 may be a device of a same type as, or a different type, from the electronic device 101. According to an embodiment, all or some of operations to be executed at the electronic device 101 may be executed at one or more of the external electronic devices 102, 104, or 108. For example, if the electronic device 101 should perform a function or a service automatically, or in response to a request from a user or another device, the electronic device 101, instead of, or in addition to, executing the function or the service, may request the one or more external electronic devices to perform at least part of the function or the service. The one or more external electronic devices receiving the request may perform the at least part of the function or the service requested, or an additional function or an additional service related to the request, and transfer an outcome of the performing to the electronic device 101. The electronic device 101 may provide the outcome, with or without further processing of the outcome, as at least part of a reply to the request. To that end, a cloud computing, distributed computing, mobile edge computing (MEC), or client-server computing technology may be used, for example. The electronic device 101 may provide ultra low-latency services using, e.g., distributed computing or mobile edge computing. In another embodiment, the external electronic device 104 may include an internet-of-things (IoT) device. The server 108 may be an intelligent server using machine learning and/or a neural network. According to an embodiment, the external electronic device 104 or the server 108 may be included in the second network 199. The electronic device 101 may be applied to intelligent services (e.g., smart home, smart city, smart car, or healthcare) based on 5G communication technology or IoT-related technology.

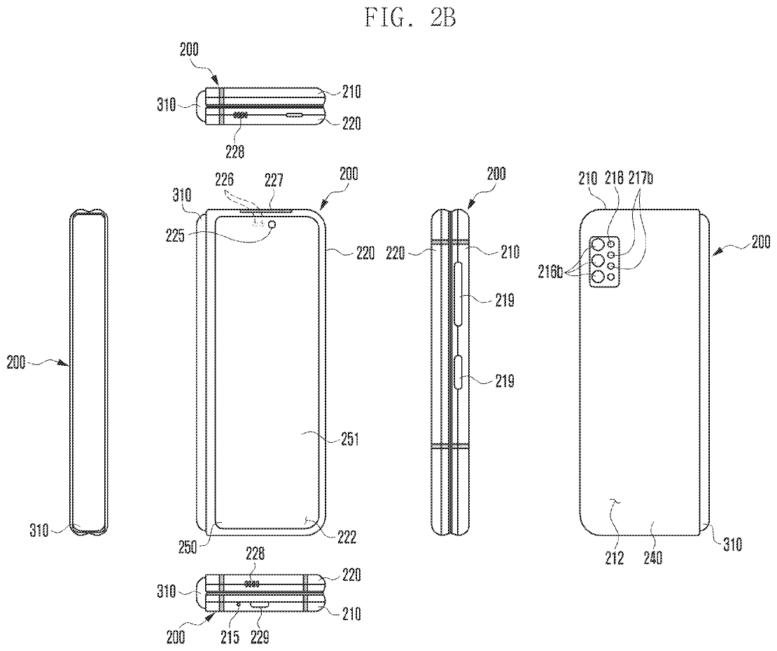

FIG. 2A is a diagram illustrating an unfolded state of an example electronic device 200 according to various embodiments. FIG. 2B is a diagram illustrating a folded state of the electronic device 200 shown in FIG. 2A.

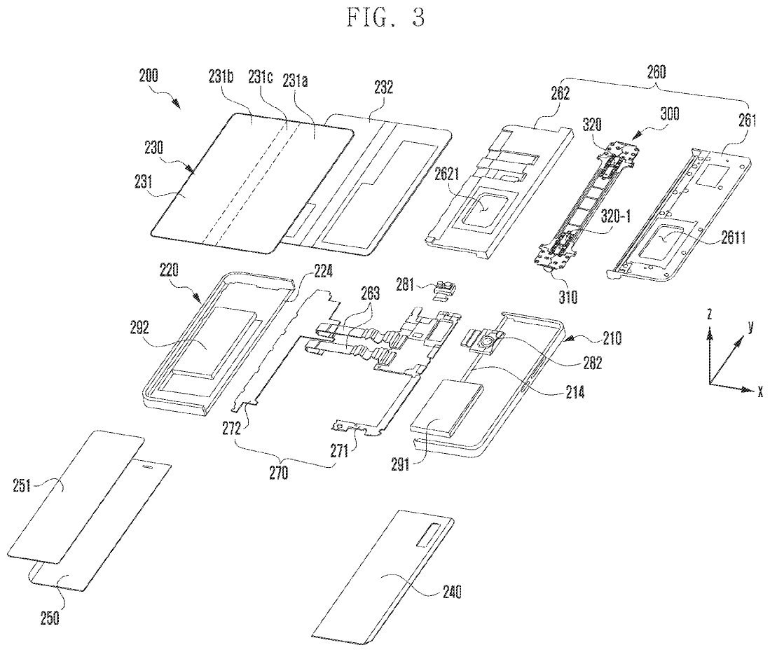

Referring to FIGS. 2A and 2B, an electronic device 200 may include a pair of housings 210 and 220 (e.g., foldable housings) rotatably combined with each other based on a folding axis A1 through a hinge device (e.g., hinge device 320 of FIG. 3) so as to be folded with each other, a first display 230 (e.g., flexible display, foldable display, and/or main display) disposed through the pair of housings 210 and 220, and a second display 400 (e.g., sub-display). According to an embodiment, the hinge device (e.g., hinge device 320 of FIG. 3) may be disposed not to be seen from an outside through the first housing 210 and the second housing 220 in a folded state, and may be disposed not to be seen from the outside through a hinge housing 310 protecting the hinge device and covering a foldable part in an unfolded state. A side on which the first display 230 is disposed may be defined as a front side of the electronic device 200, and an opposite side of the front side may be defined as a rear side of the electronic device 200. Further, a side surrounding a space between the front side and the rear side may be defined as a lateral side of the electronic device 200.

According to various embodiments, the pair of housings 210 and 220 may include the first housing 210 and the second housing 220 foldably disposed to each other through the hinge device (e.g., hinge device 320 of FIG. 3). According to an embodiment, the pair of housings 210 and 220 may not be limited to the shape and combination as illustrated in FIGS. 2A and 2B, and may be implemented by a different shape or part combinations and/or association. According to an embodiment, the first housing 210 and the second housing 220 may be disposed on both sides around the folding axis A1, and may have a symmetric shape as a whole about the folding axis A1. According to a certain embodiment, the first housing 210 and the second housing 220 may be asymmetrically folded based on the folding axis A1. According to an embodiment, the first housing 210 and the second housing 220 may have different angles or distances between them depending on whether the electronic device 200 is in an unfolded state, a folded state, or an intermediate state.

According to various embodiments, in the unfolded state of the electronic device 200, the first housing 210 may be connected to the hinge device (e.g., hinge device 320 of FIG. 3), and may include a first side 211 disposed to be directed toward the front side of the electronic device 200, a second side 212 directed toward an opposite direction of the first side 211, and a first side member 213 surrounding at least a part of a first space between at least the first side 211 and the second side 212. According to an embodiment, the second housing 220 may be connected to the hinge device (e.g., hinge device 320 of FIG. 3) in the unfolded state of the electronic device 200, and may include a third side 221 disposed to be directed toward the front side of the electronic device 200, a fourth side 222 directed toward an opposite direction of the third side 221, and a second side member 223 surrounding at least a part of a second space between at least the third side 221 and the fourth side 222. According to an embodiment, the first side 211 may be directed in the same direction as that of the third side 221 in the unfolded state, and may face the third side 221 in the folded state.

According to an embodiment, the electronic device 200 may include a recess 201 formed to accommodate the first display 230 through structural combination of the first housing 210 and the second housing 220. According to an embodiment, the recess 201 may have substantially the same size as that of the first display 230.

According to various embodiments, the hinge housing 310 (e.g., a hinge cover) may be disposed between at least the first housing 210 and the second housing 220 so as to hide the hinge device (e.g., hinge device 320 of FIG. 3). According to an embodiment, the hinge housing 310 may be hidden or exposed to an outside by parts of the first housing 210 and the second housing 220 depending on the unfolded state, the folded state, or the intermediate state of the electronic device 200. For example, in the unfolded state of the electronic device 200, the hinge housing 310 may be hidden by the first housing 210 and the second housing 220, and may not be exposed. According to an embodiment, in case that the electronic device 200 is in the folded state, the hinge housing 310 may be exposed to the outside between the first housing 210 and the second housing 220. According to an embodiment, in case of the intermediate state where the first housing 210 and the second housing 220 are folded with a certain angle, the hinge housing 310 may be at least partly exposed to the outside of the electronic device 200 between the first housing 210 and the second housing 220. For example, an area in which the hinge housing 310 is exposed to the outside may be smaller than that in a completely folded state. According to an embodiment, the hinge housing 310 may include a curved side.

According to various embodiments, in case that the electronic device 200 is in the unfolded state (e.g., state of FIG. 2A), the first housing 210 and the second housing 220 form an angle of 280 degrees, and a first area 230a, a folding area 230c, and a second area 230b of the first display 230 may be disposed to form a plane and to be directed in the same direction. As another embodiment, in case that the electronic device 200 is in the unfolded state, the first housing 210 may be rotated at an angle of 360 degrees against the second housing 220, and may be reversely folded so that the second side 212 and the fourth side 222 face each other (out folding type).

According to various embodiments, in case that the electronic device 200 is in the folded state (e.g., state of FIG. 2B), the first side 211 of the first housing 210 and the third side 221 of the second housing 220 may be disposed to face each other. In this case, the first area 230a and the second area 230b of the first display 230 may form a narrow angle (e.g., in the range of 0 to 10 degrees) with each other through the folding area 230c, and may be disposed to face each other. According to an embodiment, at least a part of the folding area 230c may be formed as a curved side having a certain curvature radius. According to an embodiment, in case that the electronic device 200 is in the intermediate state, the first housing 210 and the second housing 220 may be disposed with a certain angle. In this case, the first area 230a and the second area 230b of the first display 230 may form an angle that is larger than the angle in the folded state and smaller than the angle in the unfolded state, and the curvature radius of the folding area 230c may be larger than that in the folded state. In a certain embodiment, the first housing 210 and the second housing 220 may form a designated folding angle at which they stop folding between the folded state and the unfolded state through the hinge device (e.g., hinge device 320 of FIG. 3) (free stop function). In a certain embodiment, the first housing 210 and the second housing 220 may operate as being pressed in a folding direction or in an unfolding direction based on a designated inflection angle through the hinge device (e.g., hinge device 320 of FIG. 3).

According to various embodiments, the electronic device 200 may include at least one of displays 230 and 251 disposed on the first housing 210 and/or the second housing 220, an input device 215, sound output devices 227 and 228, sensor modules 217a, 217b, and 226, camera modules 216a, 216b, and 225, a key input device 219, an indicator (not illustrated), or a connector port 229. In a certain embodiment, the electronic device 200 may omit at least one of constituent elements, or may additionally include at least one of other constituent elements.

According to various embodiments, the at least one display 230 and 251 may include the first display 230 (e.g., flexible display) disposed to be supported by the third side 221 of the second housing 220 through the hinge device (e.g., hinge device 320 of FIG. 3) from the first side 211 of the first housing 210, and the second display 400 disposed to be seen from the outside through the fourth side 222 in the inner space of the second housing 220. According to an embodiment, the first display 230 may be mainly used in the unfolded state of the electronic device 200, and the second display 400 may be mainly used in the folded state of the electronic device 200. According to an embodiment, in the intermediate state of the electronic device 200, the first display 230 or the second display 400 may be used based on the folding angle of the first housing 210 and the second housing 220.

According to various embodiments, the first display 230 may be disposed in a space formed by the pair of housings 210 and 220. For example, the first display 200 may be seated in a recess 201 formed by the pair of housings 210 and 220, and may be disposed to occupy substantially most of the front side of the electronic device 200. According to an embodiment, the first display 230 may include the flexible display of which at least a partial area can be transformed into a planar or curved side. According to an embodiment, the first display 230 may include the first area 230a facing the first housing 210, the second area 230b facing the second housing 220, and the folding area 230c connecting the first area 230a and the second area 230b, and facing the hinge device (e.g., hinge device 320 of FIG. 3). According to an embodiment, the area division of the first display 230 is merely an exemplary physical division by a pair of housings 210 and 220 and the hinge device (e.g., hinge device 320 of FIG. 3), and the first display 230 may substantially display one seamless full screen through the pair of housings 210 and 220 and the hinge device (e.g., hinge device 320 of FIG. 3). According to an embodiment, the first area 230a and the second area 230b may have a symmetric shape as a whole based on the folding area 230c, or may have a partly asymmetric shape.

According to various embodiments, the electronic device 200 may include a first rear cover 240 disposed on the second side 212 of the first housing 210, and a second rear cover 250 disposed on the fourth side 222 of the second housing 220. In a certain embodiment, at least a part of the first rear cover 240 may be formed in a body with the first side member 213. In a certain embodiment, at least a part of the second rear cover 250 may be formed in a body with the second side member 223. According to an embodiment, at least one of the first rear cover 240 and the second rear cover 250 may be formed through a substantially transparent plate (e.g., glass plate including various coating layers or polymer plate) or an opaque plate. According to an embodiment, the first rear cover 240 may be formed through the opaque plate, such as coated or colored glass, ceramic, polymer, metal (e.g., aluminum, stainless steel (STS), or magnesium), or a combination of at least two of the above materials. According to an embodiment, the second rear cover 250 may be formed through a substantially transparent plate, such as glass or polymer. Accordingly, the second display 400 may be disposed to be seen from the outside through the second rear cover 250 in the inner space of the second housing 220.

According to various embodiments, the input device 215 may include a microphone 215. In a certain embodiment, the input device 215 may include a plurality of microphones 215 disposed to be able to detect the direction of sound. According to an embodiment, the sound output devices 227 and 228 may include speakers 227 and 228. According to an embodiment, the speakers 227 and 228 may include a call receiver 227 disposed through the fourth side 222 of the second housing 220 and an external speaker 228 disposed through the side member of the second housing 220. In a certain embodiment, the microphone 215, the speakers 227 and 228, and the connector 229 may be disposed in the spaces of the first housing 210 and/or the second housing 220, and may be exposed to an external environment through at least one hole formed on the first housing 210 and/or the second housing 220. In a certain embodiment, the holes formed on the first housing 210 and/or the second housing 220 may be commonly used for the microphone 215 and the speakers 227 and 228. In a certain embodiment, the sound output devices 227 and 228 may include a speaker (e.g., piezo-electric speaker) operating in a state where the holes formed on the first housing 210 and/or the second housing 220 are excluded.

According to various embodiments, the camera modules 216a, 216b, and 225 may include the first camera device 216a disposed on the first side 211 of the first housing 210, the second camera device 216b disposed on the second side 212 of the first housing 210, and/or the third camera device 225 disposed on the fourth side 222 of the second housing 220. According to an embodiment, the electronic device 200 may include a flash 218 disposed near the second camera device 216b. According to an embodiment, the flash 218 may include, for example, a light emitting diode or a xenon lamp. According to an embodiment, the camera devices 216a, 216b, and 225 may include one or a plurality of lenses, an image sensor, and/or an image signal processor. In a certain embodiment, at least one of the camera devices 216a, 216b, and 225 may include two or more lenses (wide-angle lens and telephoto lens) and image sensors, and may be disposed together on any one side of the first housing 210 and/or the second housing 220.

According to various embodiments, the sensor modules 217a, 217b, and 226 may generate electrical signals or data values corresponding to an internal operation state of the electronic device 200 or an external environment state. According to an embodiment, the sensor modules 217a, 217b, and 226 may include the first sensor module 217a disposed on the first side 211 of the first housing 210, the second sensor module 217b disposed on the second side 212 of the first housing 210, and/or the third sensor module 226 disposed on the fourth side 222 of the second housing 220. In a certain embodiment, the sensor modules 217a, 217b, and 226 may include at least one of a gesture sensor, a grip sensor, a color sensor, an infrared (IR) sensor, an illuminance sensor, an ultrasonic sensor, an iris recognition sensor, or a distance detection sensor (TOF sensor or RiDAR scanner).

According to various embodiments, the electronic device 200 may further include at least one of non-illustrated sensor modules, for example, a barometric pressure sensor, a magnetic sensor, a biosensor, a temperature sensor, a humidity sensor, or a fingerprint recognition sensor. In a certain embodiment, the fingerprint recognition sensor may be disposed through at least one of the first side member 213 of the first housing 210 and/or the second side member 223 of the second housing 220.

According to various embodiments, the key input device 219 may be disposed to be exposed to the outside through the first side member 213 of the first housing 210. In a certain embodiment, the key input device 219 may be disposed to be exposed to the outside through the second side member 223 of the second housing 220. In a certain embodiment, the electronic device 200 may not include parts or all of the above-mentioned key input devices 219, and the key input device 219 that is not included may be implemented in other forms, such as a soft key, on the at least one display 230 and 251. As another embodiment, the key input device 219 may be implemented using a pressure sensor included in the at least one display 230 and 251.

According to various embodiments, the connector port 229 may accommodate connectors (e.g., USB connector or interface connector port (IF) module) for transmitting or receiving a power and/or data to or from an external electronic device. In a certain embodiment, the connector port 229 may perform a function for transmitting or receiving an audio signal to or from the external electronic device together, or may further include a separate connector port (e.g., ear-jack hole) for performing audio signal transmission/reception.

According to various embodiments, at least one camera module 216a and 225 of the camera modules 216a, 216b, and 225, at least one sensor module 217a and 226 of the sensor modules 217a, 217b, and 226, and/or the indicator may be disposed to be exposed through at least one display 230 and 251. For example, the at least one camera module 216a and 225, the at least one sensor module 217a and 226, and/or the indicator may be disposed under a display area of the displays 230 and 251 in an interior space of the at least one housing 210 and 220 and be disposed to contact an external environment through an opening or transparent area perforated to a cover member (e.g., a window layer (not illustrated) of the first display 230 and/or the second rear cover 250). According to an embodiment, an area in which the displays 230 and 251 and the at least one camera module 216a and 225 face each other is a part of an area displaying contents and may be formed as a transmission area having predetermined transmittance. According to an embodiment, the transmission area may be formed to have transmittance in a range of about 5% to about 20%. Such a transmission area may include an area overlapped with an effective area (e.g., view angle area) of the at least one camera module 216a and 225 through which light for generating an image by an image sensor passes. For example, the transmission area of the displays 230 and 251 may include an area having a lower pixel density than that of a peripheral area thereof. For example, the transmission area may replace the opening. For example, the at least one camera module 216a and 225 may include an under display camera (UDC). In another embodiment, some camera modules or sensor modules 217a and 226 may be disposed to perform functions thereof without being visually exposed through the display. For example, an area facing the camera modules 216a and 225 and/or the sensor modules 217a and 226 disposed under the displays 230 and 251 (e.g., display panel) has an under display camera (UDC) structure; thus, a perforated opening may be unnecessary.

FIG. 3 is an exploded perspective view of an electronic device 200 according to various example embodiments.

Referring to FIG. 3, the electronic device 200 may include the first display 230, the second display 251, hinge module 300 comprising at least one hinge, a support member assembly 260, at least one printed circuit board 270, the first housing 210, the second housing 220, the first rear cover 240, and the second rear cover 250.

According to various embodiments, the first display 230 may include a display panel 231 (e.g., flexible display panel), and one or more plates 232 or layers on which the display panel 231 is seated. According to an embodiment, the display panel 231 may include a first panel area 231a corresponding to the first area (e.g., the first area 230a of FIG. 2A) of the display 230, a second panel area 231b extended from the first panel area and corresponding to the second area (e.g., the second area 230b of FIG. 2A) of the display 230, and a third area 231c connecting the first panel area 231a and the second panel area 231b and corresponding to a folding area (e.g., the folding area 230c of FIG. 2A) of the display 230. According to an embodiment, the one or more plates 232 may include a conductive plate (e.g., Cu sheet or SUS sheet) disposed between the display panel 231 and the support member assembly 260. According to an embodiment, the one or more plates 232 may be formed to have substantially the same area as that of the first display 230, and the area facing the folding area 230c of the first display 230c may be bendably formed. According to an embodiment, the one or more plates 232 may include at least one subsidiary material layer (e.g., graphite member) disposed on the rear side of the display panel 231. According to an embodiment, the one or more plates 232 may be formed in the shape corresponding to the display panel 231.

According to various embodiments, the second display 251 may be disposed in a space between the second housing 220 and the second rear cover 250. According to an embodiment, the second display 251 may be disposed to be seen from the outside through substantially the total area of the second rear cover 250 in the space between the second housing 220 and the second rear cover 250.

According to various embodiments, a hinge module 300 may include a hinge housing 310 and a hinge device 320. At least part of the hinge device 320 is accommodated in the hinge housing 310.

According to various embodiments, the support member assembly 260 may include a first support member 261 (e.g., first support plate), a second support member 262 (e.g., second support plate), the hinge device 320 disposed between the first support member 261 and the second support member 262, the hinge housing 310 covering the hinge device 320 as seen from the outside of the hinge device 320, and at least one wiring member 263 (e.g., flexible printed circuit board (FPCB)) crossing the first support member 261 and the second support member 262. According to an embodiment, the support member assembly 260 may be disposed between the one or more plates 232 and the at least one printed circuit board 270. According to an embodiment, the first support member 261 may be disposed between the first area 230a of the first display 230 and the first printed circuit board 271. According to an embodiment, the second support member 262 may be disposed between the second area 231b of the first display 230 and the second printed circuit board 272. According to an embodiment, inside the support member assembly 260, the at least one wiring member 263 and at least a part of the hinge device 320 may be disposed. The at least one wiring member 263 may be disposed in a direction (e.g., x-axis direction) crossing the first support member 261 and the second support member 262. According to an embodiment, the at least one wiring member 263 may be disposed in a direction (e.g., x-axis direction) that is vertical to the folding axis (e.g., y axis or folding axis A of FIG. 2A) of the folding area 231c.

According to various embodiments, the at least one printed circuit board 270 may include a first printed circuit board 271 disposed to face the first support member 261 and a second printed circuit board 272 disposed to face the second support member 262. According to an embodiment, the first printed circuit board 271 and the second printed circuit board 272 may be disposed in the inner space that is formed by the support member assembly 260, the first housing 210, the second housing 220, the first rear cover 240, and/or the second rear cover 250. According to an embodiment, the first printed circuit board 271 and the second printed circuit board 272 may include a plurality of electronic components disposed to implement various functions of the electronic device 200. According to an embodiment, the first support member 261 may be included in the first housing 210. The first support member 261 may extend at least partially toward a first space (e.g., a first inner space). According to an embodiment, the second support member 262 may be included in the second housing 220. The second support member 262 may extend at least partially toward a second space (e.g., a second inner space).

According to various embodiments, the electronic device may include the first printed circuit board 271 disposed in the space formed through the first support member 261 in the first space of the first housing 210, a first battery 291 disposed at a location facing a first swelling hole 2611 of the first support member 261, at least one camera device 282 (e.g., first camera device 216a of FIG. 2A and/or second camera device 216b), or at least one sensor module 281 comprising at least one sensor (e.g., first sensor module 217a of FIG. 2A and/or second sensor module 217b). According to an embodiment, the second space of the second housing 220 may include the second printed circuit board 272 disposed in the second space formed through the second support member 262, and a second battery 292 disposed at a location facing a second swelling hole 2621 of the second support member 262. According to an embodiment, the first housing 210 and the first support member 261 may be integrally formed. According to an embodiment, the second housing 220 and the second support member 262 may also be formed in a body.

According to various embodiments, the first housing 210 may include a first rotation support side 214, and the second housing 220 may include a second rotation support side 224 corresponding to the first rotation support side 214. According to an embodiment, the first rotation support side 214 and the second rotation support side 224 may include a curved side corresponding (naturally connected) to a curved side included in the hinge housing 310. According to an embodiment, in the unfolded state of the electronic device 200, the first rotation support side 214 and the second rotation support side 224 may cover the hinge housing 310, and may not expose the hinge housing 310 to the rear side of the electronic device 200, or for example may minimally expose the hinge housing 310. According to an embodiment, in the folded state of the electronic device 200, the first rotation support side 214 and the second rotation support side 224 may be rotated along the curved side included in the hinge housing 310, and may expose the hinge housing 310 to the rear side of the electronic device 200.

In the following description, the same or similar reference numeral may be used for the same or similar components if a specific mention does not exist.

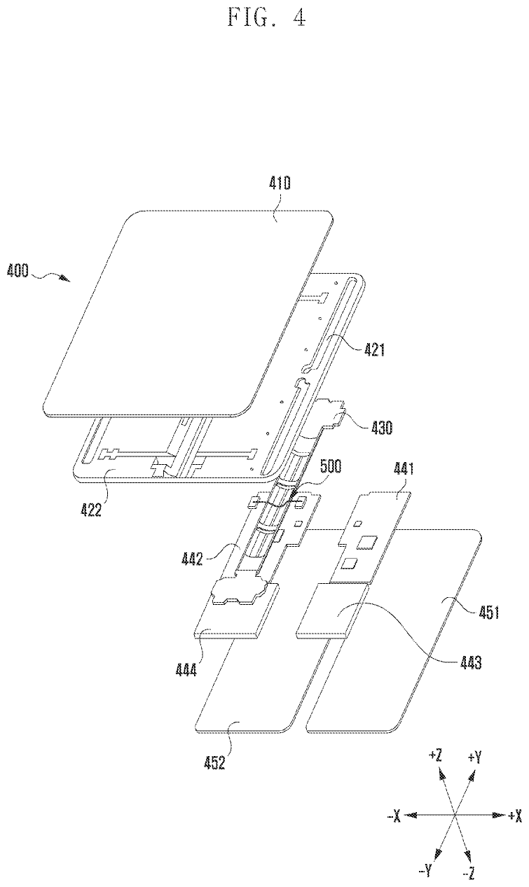

FIG. 4 is an exploded perspective view of an electronic device according to various example embodiments.

An electronic device illustrated in FIG. 4 may be an electronic device configured to be foldable, similarly to the electronic device 200 illustrated in FIG. 2A, FIG. 2B and FIG. 3.

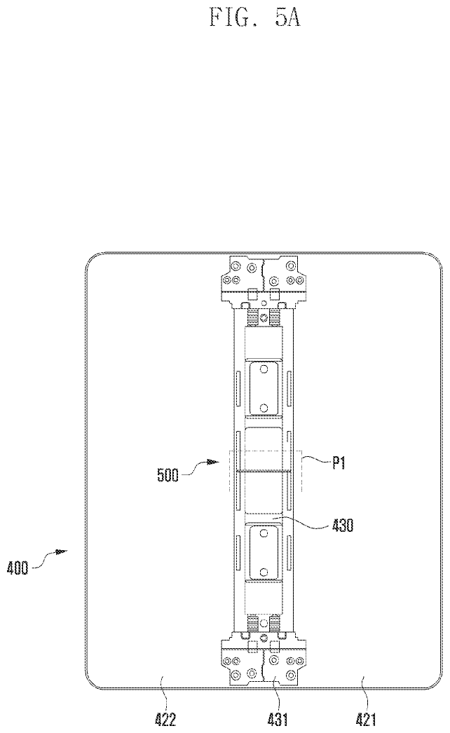

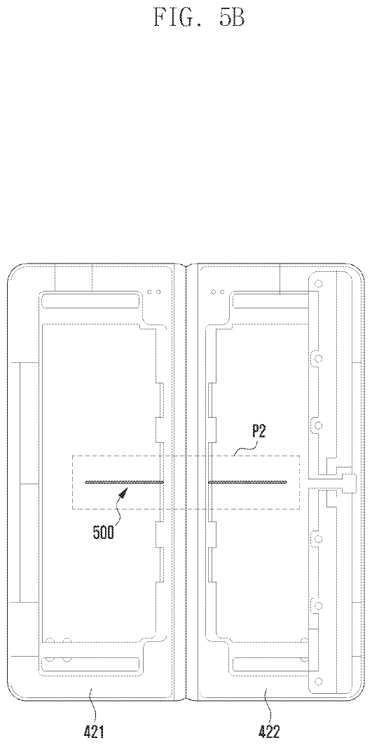

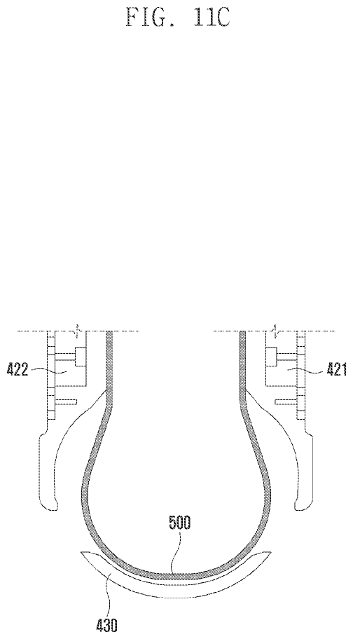

Referring to FIG. 4, an electronic device 400 may include a first housing 421 (e.g., the first housing 210 of FIG. 2A) and a second housing 422 (e.g., the second housing 220 of FIG. 2A). The first housing 421 and the second housing 422 may be connected to be foldable by a hinge device (e.g., the hinge device 320 of FIG. 3 or a hinge device 431 of FIG. 5A). The first housing 421 and the second housing 422 are folded or unfolded by the hinge device, such that the electronic device 400 may be switched into the folded state (e.g., a state illustrated in FIG. 11C) or the unfolded state (e.g., a state illustrated in FIG. 11A).

In an embodiment, at least a part of the hinge device may be accommodated in a hinge housing 430 (e.g., the hinge hosing of FIG. 3). The hinge housing 430 may be disposed between at least the first housing 421 and the second housing 422. The first housing 421 and the second housing 422 may be rotated by the hinge device, so that at least a part of the hinge housing 430 may be covered by the first housing 421 and the second housing 422.

In an embodiment, at least a part of a flexible display module 410 of the electronic device 400 may be configured to be transformable. The flexible display module 410, comprising a flexible display, may be transformed and folded as the first housing 421 and second housing 422 are folded. The flexible display module 410 may be supported by the first housing 421 and the second housing 422.

In an embodiment, with respect to an operation of the electronic device 400, electrical objects of various types may be disposed in the first housing 421 and the second housing 422. For example, printed circuit boards 441, 442 may be disposed in the first housing 421 and the second housing 422, respectively, and electronic components of various types may be disposed in the printed circuit boards 441, 442. Referring to FIG. 4, batteries 443, 444 may be disposed in the first housing 421 and the second housing 422.

In an embodiment, a first rear cover 451 may be disposed on the first housing 421. A second rear cover 452 may be disposed on the second housing 422. The rear covers 451, 452 may be disposed on the first housing 421 and the second housing 422 to configure a rear surface appearance of the electronic device 400.

Referring to FIG. 4, the electronic device 400 may include an alloy member 500. According to an embodiment, the alloy member 500 may include a shape memory alloy which memorizes a shape under a predetermined condition. For example, the shape memory alloy may include an alloy having a property restored into the shape memorized under the predetermined condition (e.g., temperature). The shape memory alloy may include a material which enables a phase-transformation according to the temperature. The material may have an austenite shape under a specific temperature condition and may have a martensite shape at a specific temperature or less. A transformation of a predetermined level may be possible in the martensite shape. In this state, when the temperature increases, the austenite shape may be restored again. Since the austenite shape may be fixed in the specific shape, the shape may be restored into the specific shape while returning to the austenite shape. The shape memory alloy may include, for example, a titanium-nickel alloy.

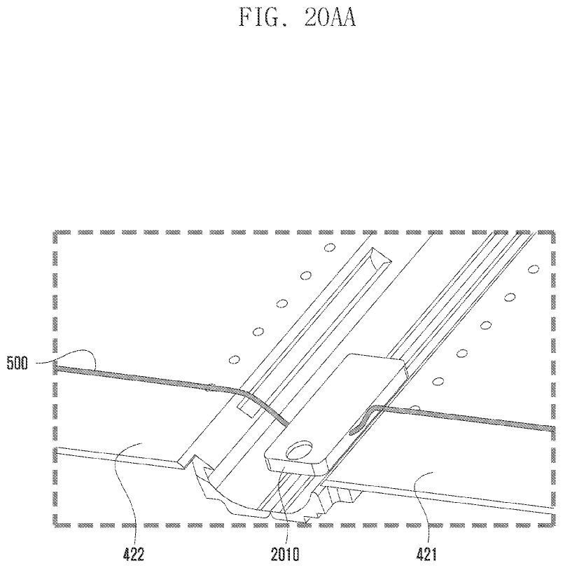

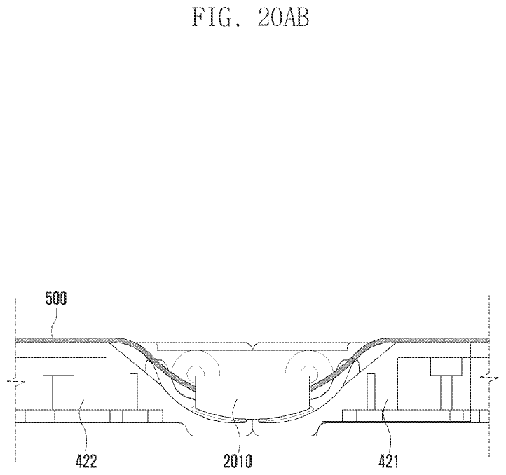

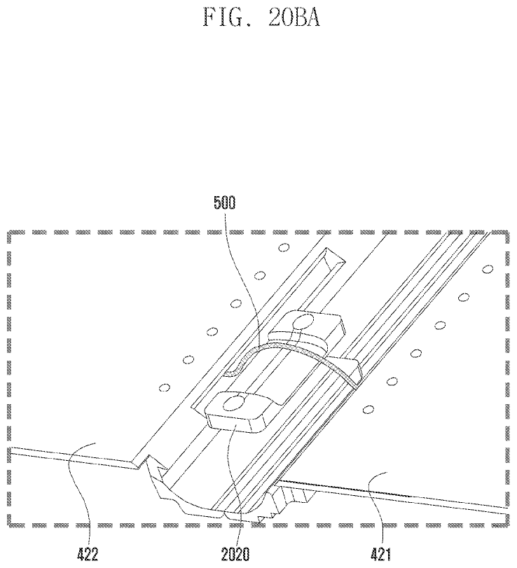

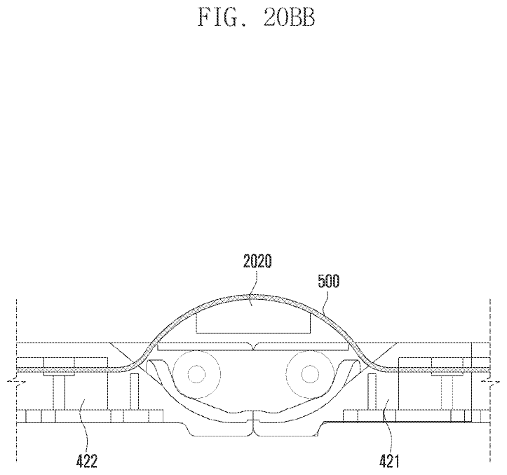

According to an embodiment, the alloy member 500 may be manufactured in various types. For example, as illustrated in FIG. 4, the alloy member 500 may be a shape extending in one direction (e.g., the X-axis direction of FIG. 4). For example, the extending direction of the alloy member 500 may be a direction perpendicular to a folded axis direction (e.g., the Y-axis direction of FIG. 4) of the electronic device 400. The alloy member 500 may be configured in various shapes, such as a bar, a wire (e.g., FIG. 20AA and FIG. 20BA), and a plate.

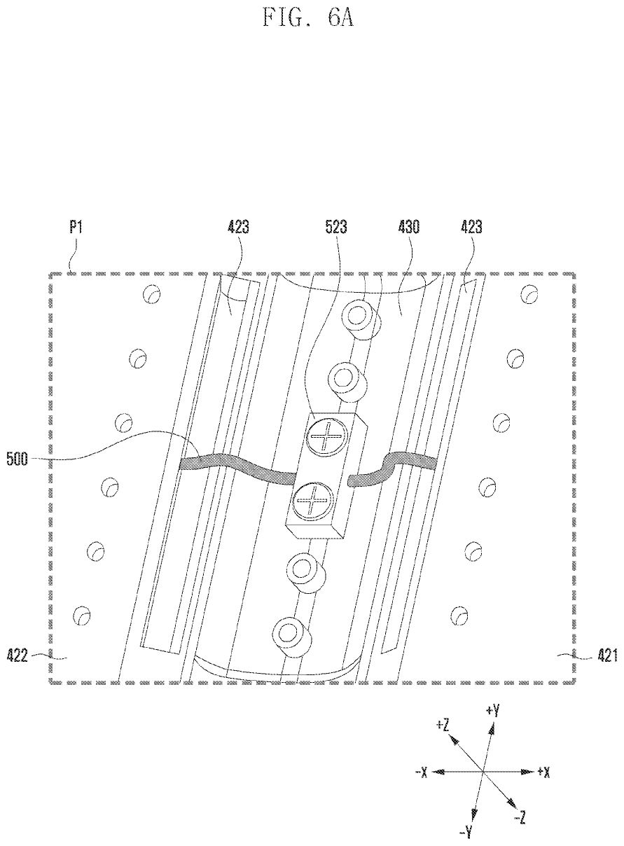

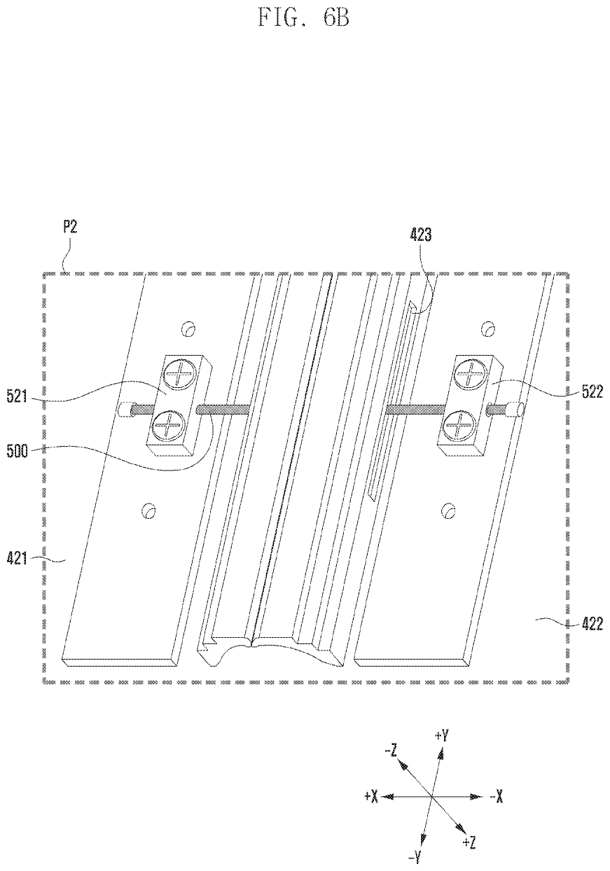

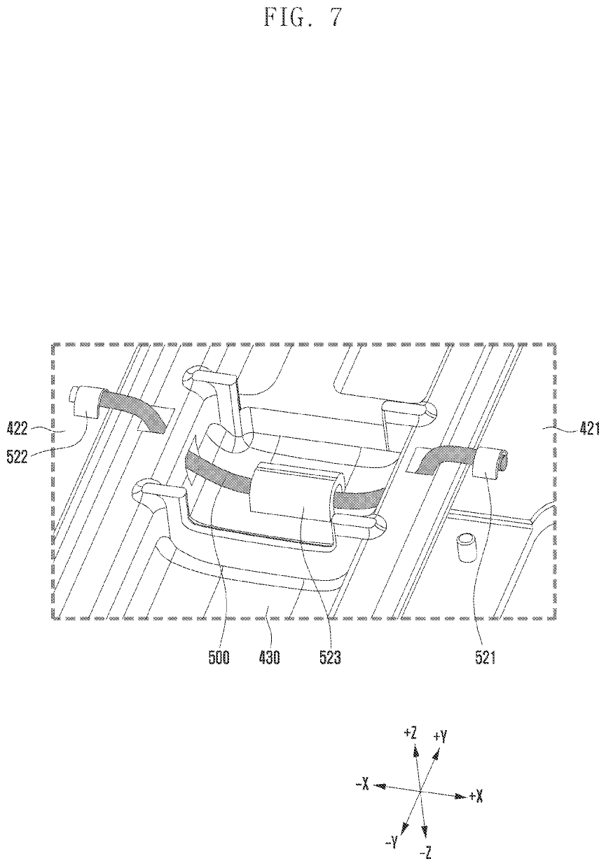

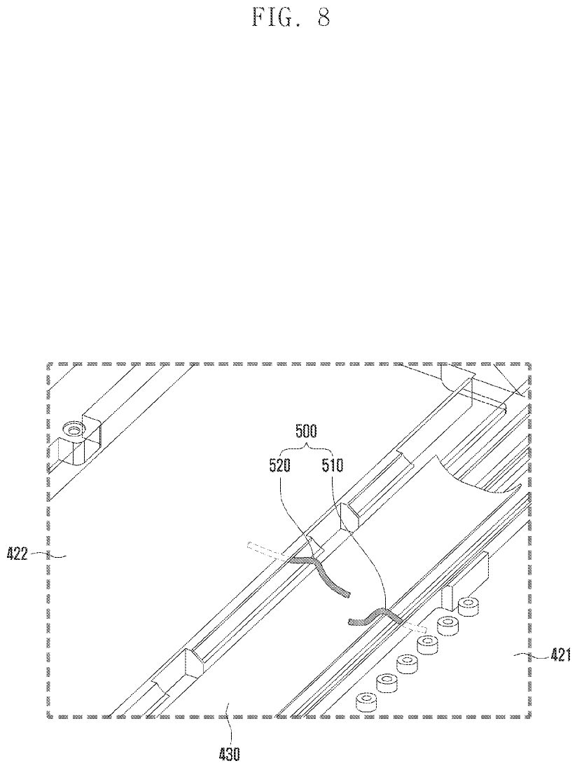

FIG. 5A is a plan view of some components of an electronic device according to various example embodiments. FIG. 5B is a rear view of an electronic device according to various example embodiments. FIG. 6A is a partial enlarged view of a P1 portion of FIG. 5A. FIG. 6B is a partial enlarged view of a P2 portion of FIG. 5B. FIG. 7 and FIG. 8 are views for illustrating a fixing method of an alloy member according to various example embodiments.

In various embodiments, at least a part of the alloy member 500 may be fixed to the first housing 421 and the second housing 422, respectively. The alloy member 500 may be fixed to the first housing 421 and/or the second housing 422 by various methods.

For example, as illustrated in FIG. 5A, FIG. 5B, FIG. 6A and FIG. 6B, one end of the alloy member 500 may be fixed to the first housing 421 by a first fixing part 521, and the other end of the alloy member 500 may be fixed to the second housing 422 by a second fixing part 522. The central part of the alloy member 500 may be fixed to the hinge device 431 disposed between at least the first housing 421 and the second housing 422 or the hinge housing 430 accommodating the hinge device 431. The central part of the alloy member 500 may be fixed to the hinge device 431 or the hinge housing 430 by a third fixing part 523. The first fixing part 521, the second fixing part 522, and the third fixing part 523 may be fixed by various methods. The first fixing part 521, the second fixing part 522, and the third fixing part 523 may be fixed through a bolt coupling, as illustrated in FIG. 6A and FIG. 6B. In addition, the first fixing part 521, the second fixing part 522, and the third fixing part 523 may be fixed through soldering, an adhesive, or a rivet. In an embodiment, the fixing methods of the first fixing part 521, the second fixing part 522, and the third fixing part 523 may be equal to or different from each other.

According to an embodiment, the hinge device 431 of the electronic device 400 may include a rotation interworking structure (e.g., a gear interworking structure). The electronic device including the hinge device 431 may be configured such that the first housing 421 and the second housing 422 may be folded or unfolded. A structure of fixing the alloy member 500 to the first housing 421, the second housing 422 and the hinge device 431 or the hinge housing 430 may be effective in case that the hinge device 431 includes the rotation interworking structure as above. In case of fixing the alloy member 500 to the first housing 421, the second housing 422 and the hinge device 431 or the hinge housing 430, the restoration force of the alloy member 500 may participate in folding or unfolding operation of first housing 421 and the second housing 422.

In addition, as illustrated in FIG. 7, one end of the alloy member 500 may be fixed by the first fixing part 521 integrally configured in the first housing 421, the other end of the alloy member 500 may be fixed by the second fixing part 522 integrally configured in the second housing 422, and the central part of the alloy member 500 may be fixed by the third fixing part 523 integrally configured in the hinge housing 430.

As illustrated in FIG. 5A, FIG. 5B, FIG. 6A and FIG. 6B, one end and the other end of the alloy member 500 may be fixed to surfaces facing a first direction (e.g., the —Z direction of FIG. 6B) in the first housing 421 and the second housing 422, respectively, and the central part of the alloy member 500 may be fixed to a surface facing a second direction (e.g., the +Z direction of FIG. 6A) opposite to the first direction in the hinge housing 430. In this case, a part of the alloy member 500 may be inserted into a slit-shaped groove 423 configured between at least the first housing 421 and the hinge housing 430 and between at least the second housing 422 and the hinge housing 430.

For another example, as illustrated in FIG. 7, one end and the other end of the alloy member 500 may be fixed to the surfaces facing the first direction (e.g., +Z direction of FIG. 7) in the first housing 421 and the second housing 422, respectively, and the central part of the alloy member 500 may be fixed to the surface facing the first direction in the hinge housing 430.

In an embodiment, as illustrated in FIG. 8, the alloy member 500 may include a first portion 510 and a second portion 520. One end of the first portion 510 may be fixed, directly or indirectly, to the first housing 421, and the other end of the first portion 510 may be fixed to the hinge device 431 or the hinge housing 430. One end of the second portion 520 may be fixed, directly or indirectly, to the second housing 422, and the other end of the second portion 520 may be fixed to the hinge device 431 or the hinge housing 430. For example, in case that the first housing 421 and the second housing 422 folded by the hinge device 431 are not interworking with each other, the first housing 421 or the second housing 422 may be individually folded. The electronic device 400, as illustrated in FIG. 8, may be configured such that an operation of folding or unfolding the electronic device 400 may be assisted through the alloy member 500 including multiple parts separated from each other (e.g., the first portion, the second portion). The first portion 510 may assist the operation of folding or unfolding the first housing 421, and the second portion 520 may assist the operation of folding or unfolding the second housing 422.

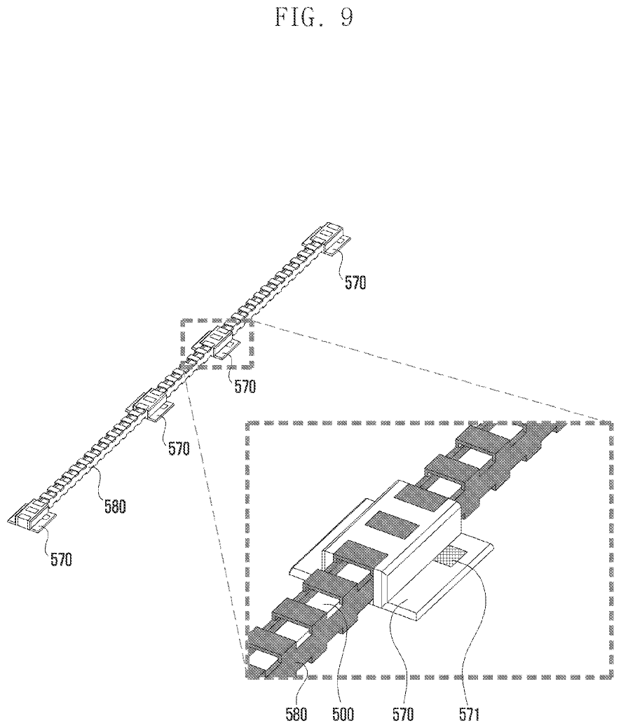

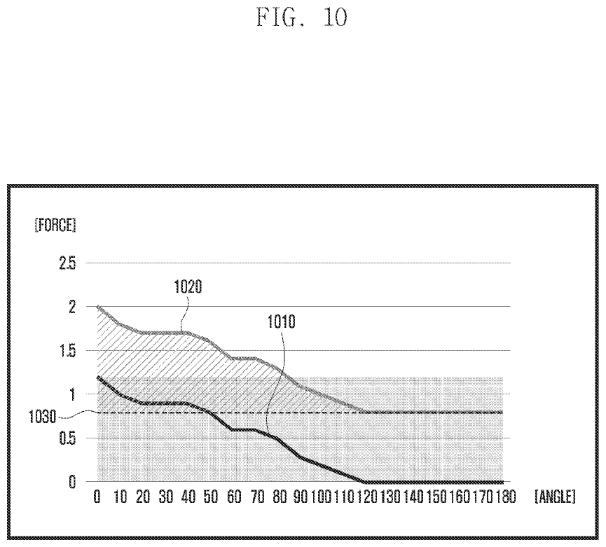

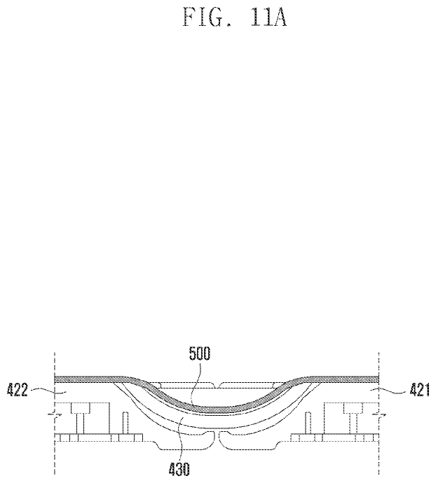

FIG. 9 is a view for illustrating an alloy member accommodated in a flexible carrier according to various example embodiments.

According to various embodiments, the alloy member 500 may be accommodated in a flexible carrier 580. The flexible carrier 580 may be made of a flexible material so that the flexible carrier 580 can be transformed together according to transformation and restoration of the alloy member 500. For example, the flexible carrier 580 may be made of a synthetic resins material. The flexible carrier 580 may include a space capable of accommodating the alloy member 500 therein.

In an embodiment, the flexible carrier 580 may be made of an insulating material. By power applied to the alloy member 500, an operation characteristic of an electronic component adjacent to the alloy member 500 may be changed. In order to prevent or reduce the change, the flexible carrier 580 surrounding the alloy member 500 may be made of an insulating material.

In an embodiment, the flexible carrier 580 may be made of an adiabatic material. In a process of increasing the temperature of the alloy member 500, in order to prevent or reduce a chance of the temperature of the surrounding electronic components from being unintentionally increased, the flexible carrier 580 may be made of an adiabatic material. In addition, when the flexible carrier 580 is made of an adiabatic material, the heat fails to easily escape to the outside of the flexible carrier 580 so that the temperature of the alloy member 500 may more promptly increase to induce more rapid restoration of the alloy member 500.

In an embodiment, the flexible carrier 580 may include a carrier fixing part 570 supporting the flexible carrier 580. A plurality of the carrier fixing parts 570 may support several parts of the flexible carrier 580. As illustrated in FIG. 9, the carrier fixing parts 570 may be disposed in one end, the other end, and the central part of the flexible carrier 580, respectively, to support the flexible carrier 580. The carrier fixing part 570 may be fixed, directly or indirectly, to the first housing (e.g., the first housing 421 of FIG. 4), the second housing (e.g., the second housing 422 of FIG. 4) or the hinge housing (e.g., the hinge housing 430 of FIG. 4) of the electronic device. For example, the carrier fixing part 570 supporting one end of the flexible carrier 580 may be fixed to the first housing, the carrier fixing part 570 supporting the other end of the flexible carrier 580 may be fixed to the second housing, and the carrier fixing part 570 supporting the central part of the flexible carrier 580 may be fixed to the hinge housing. The carrier fixing parts 570 supporting the flexible carrier 580 may be fixed to the first housing, the second housing, and the hinge housing, respectively, so that the alloy member 500 accommodated in the flexible carrier 580 may be fixed, directly or indirectly, to the first housing, the second housing and the hinge housing.

According to various embodiments, the carrier fixing part 570 may include a terminal 571. The terminal 571 may be electrically connected to the alloy member 500. In an embodiment, the carrier fixing part 570 may be fixed, directly or indirectly, to an electronical object (e.g., the printed circuit board 441, 442 of FIG. 4) of the electronic device. For example, the terminal 571 of the carrier fixing part 570 may be electrically connected to the electrical object. A driving circuit (e.g., a driving circuit 1410 of FIG. 14), which applies power to the alloy member 500, may be electrically connected to the electrical object connected to the terminal 571 of the carrier fixing part 570. The power applied from the driving circuit may be transmitted to the terminal 571 of the carrier fixing part 570 through the electrical object and may be transmitted to the alloy member 500 through the terminal 571.

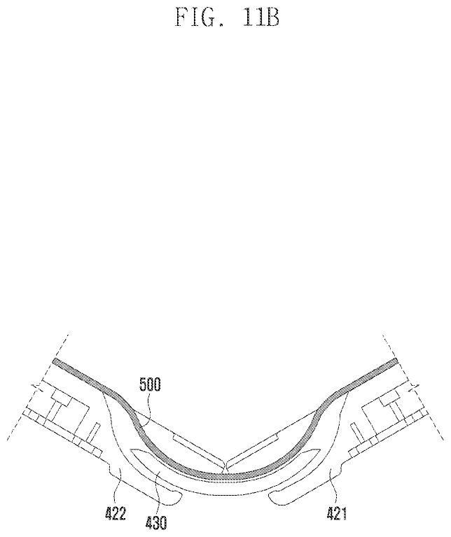

FIG. 10 is a graph showing force relating to a folded process of an electronic device according to various example embodiments. FIGS. 11A, 11B, and 11C are views for illustrating a folded or an unfolded process of an electronic device including an alloy member according to various example embodiments.

The force mainly relating to a process in which the electronic device 400 is unfolded may include the friction force of a hinge device (e.g., the hinge device 431 of FIG. 5A), the gravity applying to the electronic device 400, the repulsive force of a flexible display module (e.g., the flexible display module 410 of FIG. 4), or the restoration force of the alloy member 500. Herein, the friction force of the hinge device may include the friction force between the components of the hinge device. The friction force may indicate the friction force (e.g., the maximum stop friction force or the operation friction force) for operating the hinge device when another force does not exist. In addition, the gravity may indicate some components of the gravity applied in a direction opposite to a direction in which the electronic device 400 is unfolded. In addition, the repulsive force of the flexible display module may indicate the force to be restored into the unfolded state from the folded state of the flexible display module. In addition, the restoration force of the alloy member 500 may indicate the force to be restored into a shape memorized in the alloy member 500 under a specific condition.

Referring to FIG. 10, in case that the force which is a force 1030 or more corresponding to the sum of the gravity and the friction force of the hinge device is applied, the electronic device 400 may be unfolded. As illustrated in FIG. 10, according to progress of the unfolded operation of the electronic device 400 (according to an increase of an angle between the first housing and the second housing), the folded state of the flexible display module may be solved and a repulsive force 1010 may be reduced. When the unfolded operation of the electronic device 400 is progressed to some degrees (for example, a point at which an angle between the first housing and the second housing is about 50 degrees with reference to FIG. 10), the repulsive force 1010 of the flexible display module may become smaller than the sum 1030 of the gravity and the friction force of the hinge device. In this case, the unfolded operation may be no longer operated. In various example embodiments, the electronic device 400 may include the alloy member 500. Through the restoration force of the alloy member 500, the unfolded operation of the electronic device 400 may be continuously performed. Referring to FIG. 10, a force 1020 corresponding to the sum of the restoration force of the alloy member 500 and the repulsive force of the flexible display module may be larger than the force 1030 corresponding to the sum of the gravity and the friction force of the hinge device in the specific interval. Therefore, the unfolded operation of the electronic device 400 may be continuously performed in the corresponding interval without external force (e.g., force provided to the electronic device 400 by a user) applied to the electronic device 400. According to circumstances, the sum 1020 of the restoration force and the repulsive force may be controlled to be larger than the force 1030 corresponding to the sum of the friction force and the gravity in all intervals by controlling the restoration force of the alloy member 500. The restoration force of the alloy member 500 may be proportional to the number of the alloy member 500 and the shape of the alloy member 500 (e.g., the thickness or length). According to an embodiment, the number and the shape of the alloy member 500 may be determined by obtaining the force necessary to unfold the electronic device 400.

According to various embodiments, the alloy member 500 may memorize the shape of the alloy member 500 in the unfolded state of the electronic device 400 as illustrated in FIG. 11A. When the temperature of the alloy member 500 is reached at the temperature at which the alloy member 500 can be restored to the memorized shape, the alloy member 500 may be restored to a state illustrated in FIG. 11A. In the folded state of the electronic device 400 as illustrated in FIG. 11C, when the temperature of the alloy member 500 increases by various methods (e.g., electrical energy supply), the alloy member 500 may be restored and the electronic device 400 may be switched into the unfolded state by the restoration force of the alloy member 500. As described through FIG. 10 above, the sum of the restoration force of the alloy member 500 and the repulsive force of the flexible display module is larger than the sum of the gravity and the friction force of the hinge device, so that the electronic device 400 may be unfolded even if a user does not provide external force to the electronic device 400. Therefore, the switching of the electronic device 400 into the unfolded state may be easily performed. In an embodiment, as illustrated in FIG. 11C, the alloy member 500 may memorize the shape of the alloy member 500 when the electronic device 400 is in the folded state. In the unfolded state of the electronic device 400, when the temperature of the alloy member 500 increases to reach the restorable temperature, the electronic device 400 may be switched into the folded state by the restoration force of the alloy member 500 without providing the external power.

In another embodiment, the first alloy member storing the shape in the unfolded state of the electronic device 400 and the second alloy member storing the shape in the folded state of the electronic device 400 may be used. When the temperature of the first alloy member increases, the electronic device 400 may be switched from the folded state into the unfolded state by the restoration force of the first alloy member. When the temperature of the second alloy member increases, the electronic device 400 may be switched from the unfolded state into the folded state by the restoration force of the second alloy member.

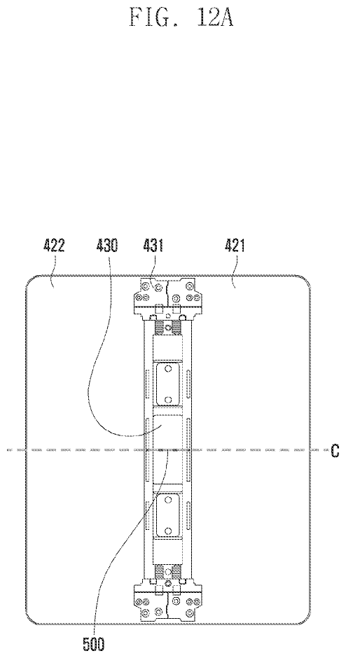

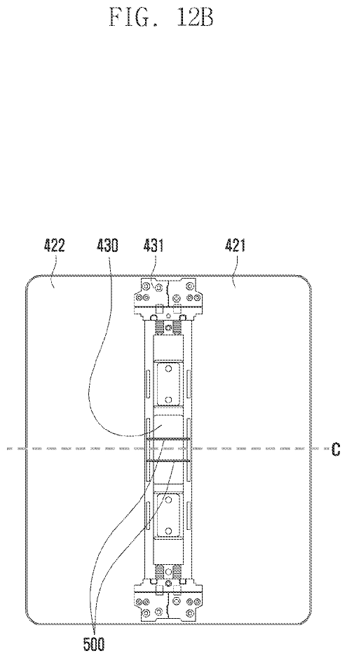

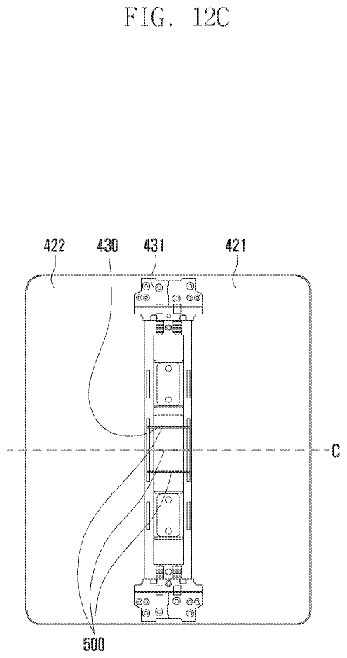

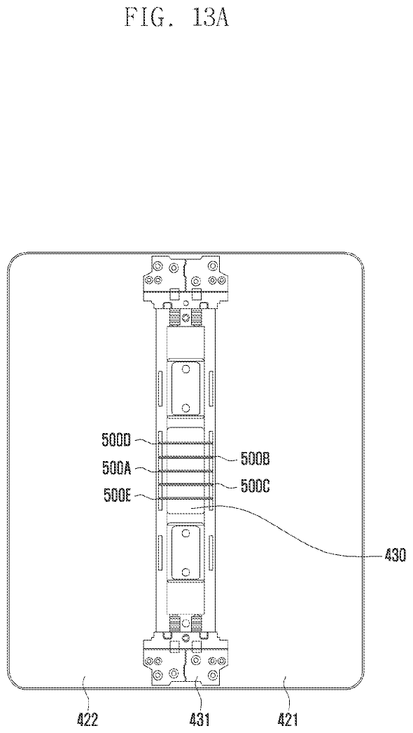

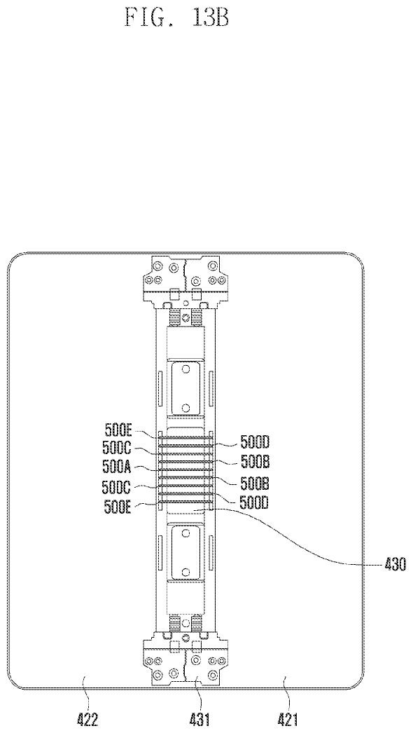

FIGS. 12A, 12B and 12C are views for illustrating a disposition of an alloy member according to various example embodiments.

According to various embodiments, the alloy member 500 may be disposed in various positions of the electronic device 400. The number, the disposition, and the shape of the alloy member 500 may be variously changed according to design elements of the electronic device 400.

In an embodiment, the alloy member 500 may be arranged and disposed in a center C of the electronic device 400, as illustrated in FIGS. 12A, 12B and 12C. As the alloy member 500 is disposed in the center C of the electronic device 400, the restoration force of the alloy member 500 may be evenly dispersed over the first housing 421 and the second housing 422 of the electronic device 400.

In an embodiment, a plurality of alloy members 500 may be provided. In case that the plurality of the alloy member 500 are provided, the alloy member 500 may be disposed symmetrically to each other with reference to the center C of the electronic device 400, as illustrated in FIG. 12B or FIG. 12C. In case that the alloy member 500 is asymmetrically disposed, the restoration force of the alloy member 500 may be unevenly applied to the first housing 421 and the second housing 422 of the electronic device 400, so that a distorting force may be applied to the electronic device 400. The alloy member 500 is disposed to be symmetrically to each other with reference to the center C of the electronic device 400, so as to solve this problem.

In an embodiment, as illustrated in FIG. 12C, in case that the number of the alloy member 500 is odd numbers, one of the alloy members 500 may be arranged and disposed in the center C of the electronic device 400, and a remaining alloy member 500 may be disposed symmetrically to each other with reference to the center C of the electronic device 400.

According to various embodiments, the plurality of the alloy members 500 may be configured as one unit. For example, the plurality of the alloy members 500 may be disposed in the flexible member by various methods, to allow the flexible member to be transformed by restoring the alloy member 500. For example, the flexible member may be a plate member.

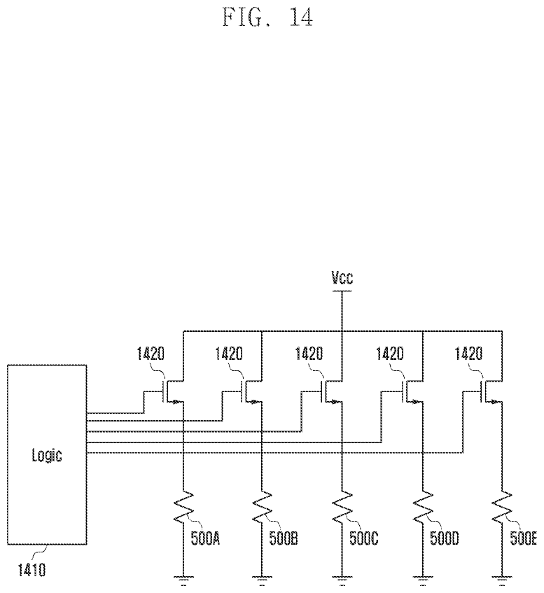

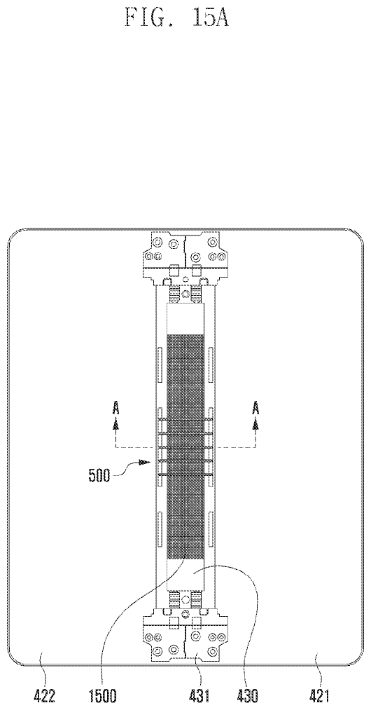

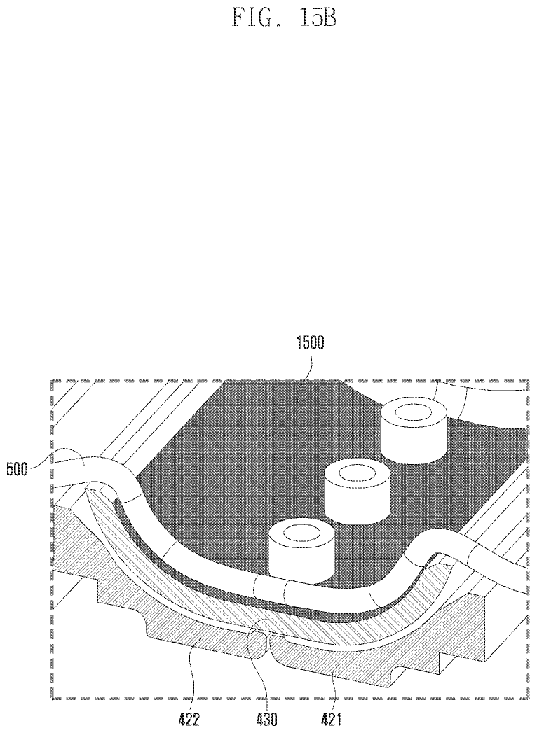

FIG. 13A and FIG. 13B are views of an electronic device including a plurality of alloy members according to various example embodiments. FIG. 14 is a schematic view of a circuit for applying power to an alloy member according to various example embodiments.

According to various embodiments, the electronic device may include the plurality of alloy members 500 restored to the shape memorized at each different temperature. For example, the electronic device may include a first alloy member 500A restored at the first temperature and a second alloy member 500B restored at the second temperature higher than the first temperature.

According to an embodiment, the driving circuit 1410 applying power to the alloy member 500 may be configured to individually supply power to the plurality of alloy members 500. For example, referring to FIG. 14, the driving circuit 1410 may be connected, directly or indirectly, through the alloy member 500 and a switch member 1420 (e.g., transistor) in parallel. According to the opening or closing of the switch member 1420 connected to each alloy member 500, power may be applied to only a part of the alloy member. In an embodiment, the driving circuit 1410 may include a circuit connected, directly or indirectly, to a processor (e.g., the processor 120 of FIG. 1) of the electronic device and controlled by the processor. In another embodiment, the driving circuit 1410 may be included in the processor of the electronic device.

According to an embodiment, in case that there is the plurality of alloy members 500 restored at each different temperature, power may be applied to a part of the plurality of the alloy members 500, based on the current temperature. Hereinafter, for convenience of explanation, the plurality of alloy members 500 include only the first alloy member 500A restored at a first temperature and the second alloy member 500B restored at a second temperature.

In an embodiment, since the alloy member 500 is transformed, an electrical connection for applying power to the alloy member 500 may be configured in a structure capable of maintaining the connection with the alloy member 500 even if the alloy member 500 is transformed. For example, the alloy member 500 may be connected, directly or indirectly, through a circuit to which power is applied, a contact pin structure having elasticity, or compressed wire.

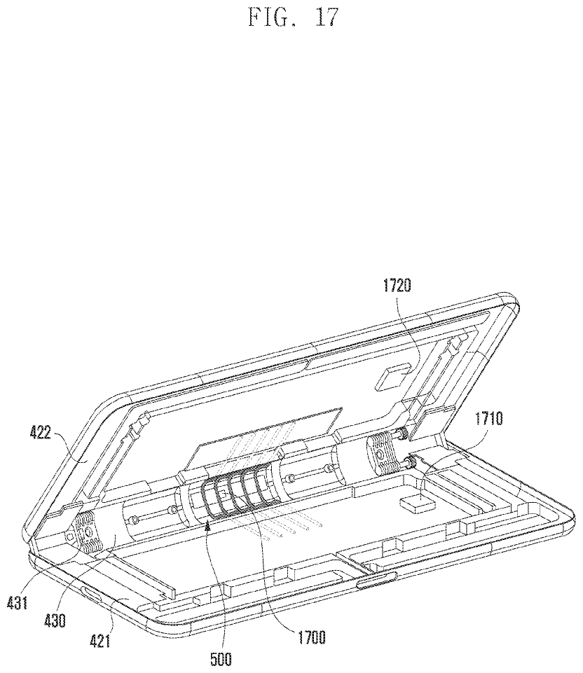

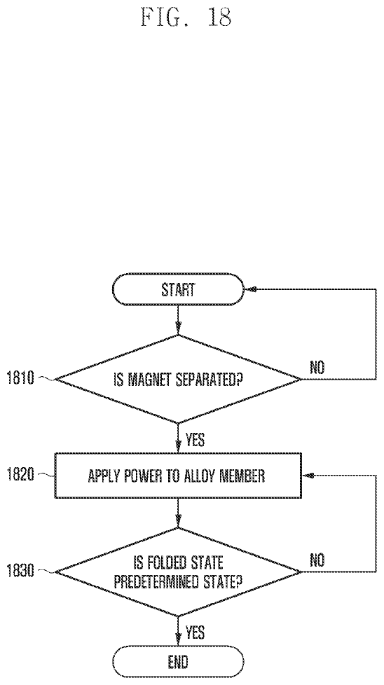

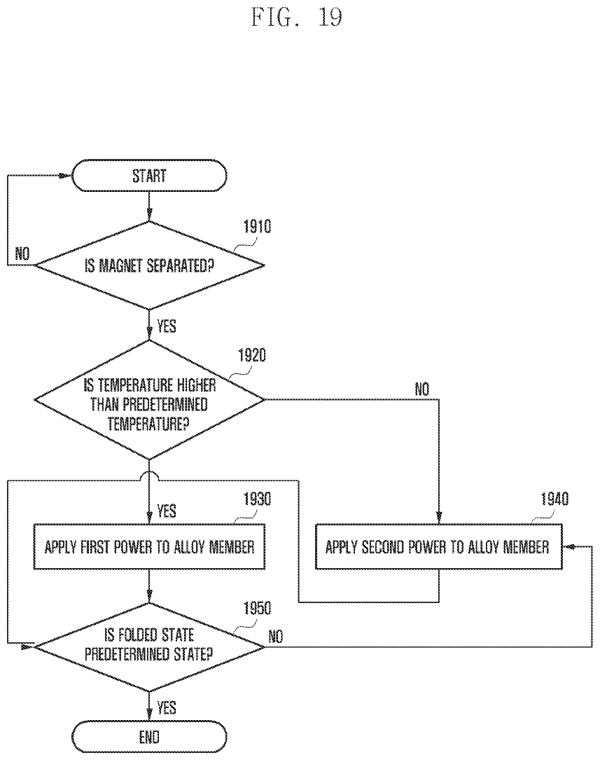

In an embodiment, the electronic device may include a temperature sensor (e.g., a temperature sensor 1700 of FIG. 17) so as to measure the temperature of the alloy member 500 or the temperature surrounding the alloy member 500. In an embodiment, the driving circuit 1410 may apply power to at least one among the first alloy member 500A and the second alloy member 500B, based on the temperature value measured by the temperature sensor. For example, in case that the temperature value measured by the temperature sensor is lower than the first temperature for restoring the first alloy member 500A and the second temperature for restoring the second alloy member 500B, the power may be applied to both the first alloy member 500A and the second alloy member 500B. In case that the temperature value measured by the temperature sensor is the value between the first temperature and the second temperature, since the first alloy member 500A may be already reached at the restoration temperature, the power may be applied to only the second alloy member 500B. Accordingly, the power may be applied to only a part of the alloy member 500 according to the temperature, such that an amount of power used for increasing the temperature of the alloy member 500 may be decreased.

According to various embodiments, a plurality of the first alloy members 500A may be provided to be disposed symmetrically to each other with reference to the center of the electronic device, and a plurality of the second alloy members 500B may be provided to be disposed symmetrically to each other with reference to the center of the electronic device. Through the disposition, the restoration force of the alloy member 500 may be evenly dispersed over the electronic device in the operations by which the first alloy member 500A or the first alloy member 500A and the second alloy member 500B are restored.

In an embodiment, both the temperature value measured by the temperature sensor and the repulsive force of the flexible display module at the temperature thereof may be considered in a process of applying power to the alloy member 500.

Hereinafter, a case that the restoration temperatures of the first alloy member to the fifth alloy member are all the same temperature will be described by the first embodiment, and a case that that the restoration temperatures of the first alloy member to the fifth alloy member are different will be described by the second embodiment.

Hereinafter, for convenience of explanation, one restoration force among the alloy members 500 is described as having a value of 70 gf, and the sum of the restoration force of the alloy member 500 is described as being directly proportional to the number of the restored alloy member 500. In addition, force for unfolding the electronic device is described having a value of 350 gf.

TABLE 1

| | | Display repulsive force | | | | |
|---|---|---|---|---|---|---|
| | | 290 gf | 220 gf | 150 gf | 80 gf | 10 gf |
| Alloy | restoration | Current temperature | | | | |
| member | temperature | 20° C. | 30° C. | 40° C. | 50° C. | 60° C. |
| First alloy | 70° C. | 1 | 1 | 1 | 1 | 1 |
| member | | | | | | |
| Second alloy | 70° C. | 0 | 1 | 1 | 1 | 1 |
| member | | | | | | |
| Third alloy | 70° C. | 0 | 0 | 1 | 1 | 1 |
| member | | | | | | |
| Fourth alloy | 70° C. | 0 | 0 | 0 | 1 | 1 |
| member | | | | | | |
| Fifth alloy | 70° C. | 0 | 0 | 0 | 0 | 1 |
| member | | | | | | |
| | Restoration | 70 gf | 140 gf | 210 gf | 280 gf | 350 gf |
| | force sum | | | | | |

Referring to Table 1, the first embodiment will be described. The number “1” in Table 1 may be understood as indicating that the alloy member has reached the restoration temperature and has been restored.

The Table 1 is to explain a case of using the first alloy member to the fifth alloy member having the same restoration temperature of 70 degrees. The repulsive force of the flexible display module (e.g., the flexible display module 410 of FIG. 4) may decrease as the temperature increases. The current temperature of Table 1 may indicate the temperature of the space in which the flexible display module is disposed. Referring to Table 1, the repulsive force of the flexible display module may decrease as the current temperature increases.

For example, in case that the current temperature is 20 degrees, the repulsive force of the flexible display module is 290 gf and force for unfolding the electronic device is 350 gf, so that a force of at least 60 gf may be further necessary in order to unfold the electronic device. Since the restoration force of one alloy member 500 is 70 gf, the sum of the repulsive force of the flexible display module and the restoration force of the alloy member 500 becomes 360 gf to enable the electronic device to be unfolded when power is applied to enable one of the alloy members 500 to be reached at the restoration temperature.

For example, in case that the current temperature is 60 degrees, the repulsive force of the flexible display module is 10 gf, and the force of at least 340 gf may be further necessary in order to unfold the electronic device. Since the restoration force of one alloy member 500 is 70 gf, the sum of the repulsive force of the flexible display module and the restoration force of five alloy members 500 becomes 360 gf to enable the electronic device to be unfolded when power is applied to all of the five alloy members 500.

As above, in case of using the plurality of the alloy members 500 having the same restoration temperature, power may be applied to the plurality of the alloy member 500 according to the repulsive force of the flexible display module changed according to the temperature.

TABLE 2

| | | Display repulsive force | | | | |
|---|---|---|---|---|---|---|
| | | 290 gf | 220 gf | 150 gf | 80 gf | 10 gf |
| Alloy | restoration | Current temperature | | | | |
| member | temperature | 20° C. | 30° C. | 40° C. | 50° C. | 60° C. |
| First alloy | 30° C. | 1 | 1 | 1 | 1 | 1 |
| member | | | | | | |
| Second alloy | 40° C. | 0 | 1 | 1 | 1 | 1 |
| member | | | | | | |
| Third alloy | 50° C. | 0 | 0 | 1 | 1 | 1 |
| member | | | | | | |
| Fourth alloy | 60° C. | 0 | 0 | 0 | 1 | 1 |
| member | | | | | | |
| Fifth alloy | 70° C. | 0 | 0 | 0 | 0 | 1 |
| member | | | | | | |
| | Restoration | 70 gf | 140 gf | 210 gf | 280 gf | 350 gf |
| | force sum | | | | | |

Referring to Table 2, the second embodiment will be described. The number “1” in Table 2 may be understood indicating that the alloy member has reached the restoration temperature and has been restored.

The alloy member 500 of the second embodiment may include the plurality of the alloy members 500 having each different restoration temperature, differently from the alloy member 500 of the first embodiment. Referring to Table 2, the alloy member 500 may include the first alloy member 500A restored at 30 degrees, the second alloy member 500B restored at 40 degrees, a third alloy member 500C restored at 50 degrees, a fourth alloy member 500D restored at 60 degrees, and a fifth alloy member 500E restored at 70 degrees.

In an embodiment, even though a part of the alloy member 500 is restored, the plurality of the first alloy member 500A to the fifth alloy member 500E may be individually provided to be disposed symmetrically to each other with reference to the center of the electronic device so that force can be evenly dispersed to the electronic device. In another embodiment, one of the first alloy member 500A to the fifth alloy member 500E may be disposed in the center of the electronic device, and the remaining alloy members 500 may be disposed symmetrically to each other with reference to the center of the electronic device. For example, as described in FIG. 13B, the first alloy member 500A may be arranged and disposed in the center of the electronic device, and the plurality of the remaining alloy members 500B, 500C, 500D, 500E may be disposed symmetrically to each other with reference to the center of the electronic device.

In another embodiment, as illustrated in FIG. 13A, the first alloy member 500A may be disposed to be arranged in the center of the electronic device, the second alloy member 500B and the third alloy member 500C may be disposed symmetrically to each other with reference to the center of the electronic device, and the fourth alloy member 500D and the fifth alloy member 500E may be disposed symmetrically to each other with reference to the center of the electronic device.

For convenience of explanation, in case of the plurality of the first alloy member 500A to the fifth alloy member 500E, the sum of the restoration force of each alloy member 500 is described having a value of 70 gf. In an embodiment, the sum of the restoration force may be controlled to be substantially equal to each other, by controlling the thickness of each allow member 500. For example, in case of FIG. 13B, the first alloy member 500A may have the number smaller than that of other alloy members 500 but have the relatively thick thickness, so that the first alloy member 500A may have substantially the same restoration force as other alloy members 500.

In case of the temperature at 20 degrees, the repulsive force of the flexible display module may be 290 gf. At this temperature, power may be applied to only the first alloy member 500A. When the first alloy member 500A is reached at the restoration temperature, the sum of the restoration force of the first alloy member 500A and the repulsive force of the flexible display module may be 360 gf. The force for unfolding the electronic device is 350 gf, so that the electronic device may be unfolded.

In case of the temperature at 30 degrees, the repulsive force of the flexible display module may be 220 gf. At 30 degrees, the first alloy member 500A may be restored even if the power is not applied. Therefore, the sum of the restoration force of the first alloy member 500A and the second alloy member 500B becomes 140 gf when power is applied to only the second alloy member 500B to enable the second alloy member 500B to be reached at the restoration temperature, so that the sum of the restoration force and the repulsive force of the flexible display module may become 360 gf. The force for unfolding the electronic device is 350 gf, so that the electronic device may be unfolded.

In case of the temperature at 40 degrees, the repulsive force of the flexible display module may be 150 gf. At 40 degrees, the first alloy member 500A and the second alloy member 500B may be restored even if power is not applied. Therefore, the sum of the restoration force of the first alloy member 500A to the third alloy member 500C becomes 210 gf when the power is applied to only the third alloy member 500C to enable the third alloy member 500C to be reached at the restoration temperature, so that the sum of the restoration force and the repulsive force of the flexible display module may become 360 gf. The force for unfolding the electronic device is 350 gf, so that the electronic device may be unfolded.

In case of the temperature at 50 degrees, the repulsive force of the flexible display module may be 80 gf. At 50 degrees, the first alloy member 500A to the third alloy member 500C may be restored even if the power is not applied. Therefore, the sum of the restoration force of the first alloy member 500A to the fourth alloy member 500D becomes 280 gf when the power is applied to only the fourth alloy member 500D to enable the fourth alloy member 500D to be reached at the restoration temperature, so that the sum of the restoration force and the repulsive force of the flexible display module may become 360 gf. The force for unfolding the electronic device is 350 gf, so that the electronic device may be unfolded.

In case of the temperature at 60 degrees, the repulsive force of the flexible display module may be 10 gf. At 60 degrees, the first alloy member 500A to the fourth alloy member 500D may be restored even if the power is not applied. Therefore, the sum of the restoration force of the first alloy member 500A to the fifth alloy member 500E becomes 350 gf when the power is applied to only the fifth alloy member 500E to enable the fifth alloy member 500E to be reached at the restoration temperature, so that the sum of the restoration force and the repulsive force of the flexible display module may become 360 gf. The force for unfolding the electronic device is 350 gf, so that the electronic device may be unfolded.

In the second embodiment, in the temperature range of 20 degrees to 60 degrees, the sum of the restoration force and the repulsive force exceeds the force necessary to unfold the electronic device when the power is applied to only one among the first alloy member 500A to the fifth alloy member 500E, so that the electronic device may be unfolded. Therefore, differently from the first embodiment, the amount of power applied for restoring the alloy member 500 may be reduced.

The first embodiment and the second embodiment, described through Table 1 and Table 2, may be merely the examples, and the design elements such as the restoration temperature, the number or the thickness of the alloy member 500 may be variously changed in consideration of the repulsive force of the flexible display module according to the change of the temperature.

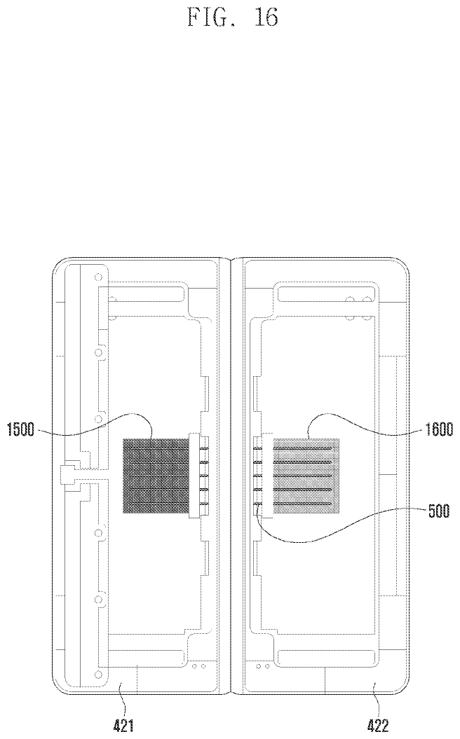

FIG. 15A is a view of an electronic device including a heat dissipation member according to various example embodiments. FIG. 15B is a cross-sectional perspective view of FIG. 15A taken along line A-A. FIG. 16 is a view of an electronic device including a heat dissipation member according to various example embodiments.

According to various embodiments, the alloy member 500 may be used as a heat transfer medium. The alloy member 500 includes alloy materials, so that thermal conductivity thereof may be high. The heat of a heating component 1600 may be transferred to a heat dissipation member 1500 by using the alloy member 500.

As illustrated in FIG. 15A and FIG. 15B, the alloy member 500 and the heat dissipation member 1500 may be disposed so that a part of the alloy member 500 and the heat dissipation member 1500 are to be in contact with each other. The heat dissipation member 1500, for example, may include a graphite sheet. In an embodiment, as illustrated in FIG. 16, one end of the alloy member 500 may be disposed to be in contact with the heating component 1600 (e.g., processor, camera, or battery, etc.) and the other end of the alloy member 500 may be disposed to be in contact with the heat dissipation member 1500. Heat generated from the heating component 1600 is transferred to the heat dissipation member 1500 through the alloy member 500 so that heat dissipation may be performed. In another embodiment, as illustrated in FIG. 15A and FIG. 15B, the heat dissipation member 1500 may be disposed to be in contact with the central part of the alloy member 500. According to another case, the heat dissipation member 1500 may be disposed so that the heat dissipation member 1500 is to be in contact with the central part of the alloy member 500 and one end or the other end of the alloy member 500.

In an embodiment, in case that the alloy member 500 and the heat dissipation member 1500 are disposed to be in contact with each other, when the temperature of a part of the alloy member 500 increases by power applied to a part of the plurality of the alloy member 500, the temperature of the adjacent alloy members 500 may also increase by the heat dissipation member 1500. Through this, the power necessary to increase the temperature of the plurality of the alloy members 500 may be decreased.

In an embodiment, in case that the alloy member 500 is adjacent to the heating component 1600, the temperature of the alloy member 500 may increase by the temperature of the heating component 1600. Through this, the alloy member 500 may be easily reached at the restoration temperature, without supply of the separate power. In addition, the temperature of the flexible display module (e.g., the flexible display module 410 of FIG. 4) may increase as the temperature of the alloy member 500 increases. The flexible characteristic of the flexible display module may be reduced at the low temperature. A case that the flexible display module is transformed at the low temperature may receive damage heavier than a case that the flexible display module is transformed at the high temperature. The heavy damage may not occur in a process in which the temperature of the flexible display module is maintained at the certain level by the temperature increase of the alloy member 500 to transform the flexible display module. In another embodiment, in order to prevent or reduce damage of the flexible display module at the low temperature circumstance, the temperature of the alloy member 500 may be increased by applying power to the alloy member 500.

In an embodiment, the heat of the alloy member 500 may be dispersed through the heat dissipation member 1500. The heat of the alloy member 500 is dispersed through the heat dissipation member 1500 in a state in which the power is not applied to the alloy member 500, so that the temperature of the alloy member 500 may be rapidly reduced. The temperature of the alloy member 500 is rapidly decreased at the restoration temperature, so that immediacy of the folded or unfolded assistance operation control may be improved through the alloy member 500.

FIG. 17 is a perspective view of an electronic device including an alloy member according to various example embodiments. FIG. 18 and FIG. 19 are flowcharts illustrating a method of controlling an alloy member of an electronic device according to various example embodiments.

According to various embodiments, a first magnet 1710 may be disposed in the first housing 421, and a second magnet 1720 may be disposed in the second housing 422. The first magnet 1710 and the second magnet 1720 may be disposed at positions facing each other when the electronic device 400 is in the folded state. The folded state of the electronic device 400 may be maintained by attractive force of the first magnet 1710 and the second magnet 1720.

In an embodiment, a power application of the alloy member 500 through the driving circuit (e.g., the driving circuit 1410 of FIG. 14) may be performed based on separation of the first magnet 1710 and the second magnet 1720. The separation of the first magnet 1710 and the second magnet 1720 may be sensed by a separation sensor (not illustrated). For example, the separation sensor may include a hall sensor capable of detecting change of a magnetic field. In another example, the separation sensor may include a motion sensor (e.g., an acceleration sensor, a geomagnetic sensor, or a gyro sensor, etc.) capable of sensing an operation of the first housing 421 and the second housing 422.

Referring to FIG. 18, the processor (e.g., the processor 120 of FIG. 1) may detect the separation of the first magnet 1710 and the second magnet 1720 by a separation sensor in operation 1810. When the separation of the first magnet 1710 and the second magnet 1720 are detected, the power may be applied to the alloy member 500 by controlling the driving circuit in operation 1820. The first magnet 1710 and the second magnet 1720 are configuration components for maintaining the folded state of the electronic device 400, so that the separating of the first magnet 1710 and the second magnet 1720 may be interpreted as a user has an intention of switching the electronic device 400 into the unfolded state. Based on the separation of the first magnet 1710 and the second magnet 1720, the alloy member 500 may be reached at the restoration temperature when the power is applied to the alloy member 500. The restoration force of the alloy member 500 may be applied to enable the electronic device 400 to be unfolded by the restoration force of the alloy member 500 reached at the restoration temperature.

In addition, a situation in which the electronic device 400 is to be switchable into the unfolded state may be identified by various methods, so that power may be applied to the alloy member 500. For example, the power may be applied to the alloy member 500 by sensing a fixing release operation corresponding to various methods (e.g., a clip, a ring, a button, or a driving power of a motor, etc.) for fixing the first housing 421 and the second housing 422 in the folded state. For another example, the power may be applied to the alloy member 500, based on a grip state of the electronic device 400. The grip state of the electronic device 400 may be identified by using a sensor capable of recognizing a contact of the electronic device 400 with the skin of a user (e.g., a grip sensor or a touch sensor of the display). In addition, the power may be applied to the alloy member 500, based on an angle made by the first housing 421 and the second housing 422 or various triggers for the unfolding or folding operation (e.g., a button input, a touch input through a display, or an operation start point recognition of a motor, etc.).

In an embodiment, the processor may identify the folded state of the electronic device 400 detected using a folding sensor (not illustrate). The folding sensor may be a sensor capable of identifying how much the electronic device 400 has been folded or unfolded. The folding sensor may sense the folded state by identifying a relative distance between a part of the first housing 421 (e.g., one edge of the first housing 421) and a part of the second housing 422 (e.g., one edge of the second housing 422). An angle made by the first housing 421 and the second housing 422 may be identified when a disposition position of the folding sensor and the relative distance of the first housing 421 and the second housing 422 are known. The folding state of the electronic device 400 may be identified through the angle. The folding sensor may include, for example, a hall sensor which detects the change of a magnetic field or a motion sensor capable of sensing an operation of the first housing 421 and the second housing 422 (e.g., an acceleration sensor, a geomagnetic sensor, or a gyro sensor, etc.).

In an embodiment, the processor may identify that the folded state has reached the predetermined state in operation 1830. When the folded state is reached into the predetermined state, the driving circuit may be controlled to stop a power application of the alloy member 500. For example, the predetermined state may be a state in which the angle made by the first housing 421 and the second housing 422 is 170 degrees or more.

In another embodiment, the power applied to the alloy member 500 may be determined based on the temperature value sensed by the temperature sensor 1700 disposed adjacent to the alloy member 500. The speed of the operation of unfolding the electronic device 400 by the alloy member 500 may be determined by the surrounding temperature of the alloy member 500. For example, the speed of unfolding the electronic device 400 by the alloy member 500 may be slow in a state of the low temperature. In an embodiment, in the low temperature circumstance, more power is applied to rapidly increase the temperature of the alloy member 500.

In an embodiment, the processor may identify a temperature value measured by the temperature sensor 1700, so that the driving circuit may control the amount of power applied to the alloy member 500 according to the temperature value. For example, in case that the temperature value is lower than the predetermined temperature value (e.g., about 20 degrees), the driving circuit may be controlled so that the amount of power higher than that of the general case is to be applied to the alloy member 500.

Referring to FIG. 19, the processor may identify the separation of the first magnet 1710 and the second magnet 1720 in operation 1910. When the first magnet 1710 and the second magnet 1720 are separated, the processor may identify whether the temperature measured through the temperature sensor 1700 is higher than the predetermined temperature in operation 1920.

In case that the measured temperature is higher than the predetermined temperature, a first power is applied to the alloy member 500 in operation 1930. On the other hand, in case that the temperature is equal to or lower than the determined temperature, a second power may be applied to the alloy member 500 in operation 1940. Herein, the second power may have an amount of power higher than that of the first power. In case that the temperature measured by the temperature sensor 1700 is equal to or lower than the predetermined temperature, the amount of power relatively higher than a case that the measured temperature is higher than the determined temperature may be applied to the alloy member 500, so that the alloy member 500 may be controlled to be rapidly reached at the restoration temperature.

The processor may identify that the folded state is reached into the predetermined state in operation 1950. In case that the folded state is reached into the predetermined state, the driving circuit may be controlled to stop a power application of the alloy member 500.

FIGS. 20AA and 20BA are perspective views illustrating a part of an electronic device including an alloy member having a contracting or an expanding wire shape according to various example embodiments. FIGS. 20AB and 20BB are cross-sectional views corresponding to the electronic device of FIGS. 20AA and 20BA.

In an embodiment, the alloy member 500 may be contracted or expanded according to the temperature. The alloy member 500 may be configured in a wire shape. In case that the alloy member 500 is used, the electronic device may be switched into the folded or the unfolded state according to a fixing method of the alloy member 500.

For example, as illustrated in FIG. 20AA and FIG. 20AB, in case that the fixing position of an intermediate portion of the alloy member 500 is lower than the fixing position of one end and the other end of the alloy member 500, the electronic device may be folded according to contraction of the alloy member 500. In an embodiment, the intermediation portion of the alloy member 500 may be fixed by a fixing member 2010 disposed to be lower than one surface of the first housing 421 and the second housing 422 with reference to the FIG. 20AA.

For example, as illustrated in FIG. 20BA and FIG. 20BB, in case that the fixing position of the intermediate portion of the alloy member 500 is higher than the fixing position of one end and the other end of the alloy member 500, the electronic device may be unfolded according to contraction of the alloy member 500. In an embodiment, the intermediate portion of the alloy member 500 may be fixed by the fixing member 2020 disposed to be higher than one surface of the first housing 421 and the second housing 422 with reference to FIG. 20BB.

An electronic device (e.g., the electronic device 101 of FIG. 1, the electronic device 200 of FIG. 2A, the electronic device 400 of FIG. 4) according to various example embodiments may include a first housing (e.g., the first housing 421 of FIG. 4), a second housing (e.g., the second housing 422 of FIG. 4), a hinge device (e.g., the hinge device 431 of FIG. 5A) configured to connect the first housing and the second housing so that the electronic device is switched from a folded state into an unfolded state, a first alloy member (e.g., the alloy member 500 of FIG. 12), at least a part of which is fixed, directly or indirectly, to the first housing, the second housing, and the hinge device and which is made of a shape memory alloy material, a second alloy member (e.g., the alloy member 500 of FIG. 12), at least a part of which is fixed, directly or indirectly, to the first housing and the second housing at a position different from the first alloy member and which is made of a shape memory alloy material, and a driving circuit (e.g., the driving circuit 1410 of FIG. 14) configured to apply power to at least one of the first alloy member and the second alloy member so that at least one of the first alloy member and the second alloy member is restored.

In addition, the electronic device may further include a temperature sensor (e.g., the temperature sensor 1700 of FIG. 17) disposed adjacent to the first alloy member and the second alloy member, wherein the driving circuit is configured to control an amount of power applied to at least one of the first alloy member and the second alloy member, based on a temperature value measured by the temperature sensor.

In addition, the electronic device may further include a folding sensor configured to sense a folded state of the electronic device, wherein the driving circuit is configured to control an amount of the power applied to at least one of the first alloy member and the second alloy member, based on a folded state sensed by the folding sensor.

In addition, the electronic device may further include a temperature sensor disposed adjacent to the first alloy member and the second alloy member, wherein the first alloy member is configured to be restored at a first temperature, the second alloy member is configured to be restored at a second temperature higher than the first temperature, and the driving circuit may be configured to apply power so that the first alloy member reaches the first temperature or to apply power so that the second alloy member reaches the second temperature, based on the temperature value measured by the temperature sensor.

In addition, the first alloy member and the second alloy member may be disposed symmetrically to each other with reference to a center of the electronic device.

In addition, a plurality of the first alloy members may be provided to be disposed symmetrically to each other with reference to the center of the electronic device, and a plurality of the second alloy members are provided to be disposed symmetrically to each other with reference to the center of the electronic device.

In addition, the electronic device may further include a flexible display module (e.g., the flexible display module 410 of FIG. 4), at least a part of which is disposed in the first housing and the second housing and which is configured to be foldable, wherein the flexible display module is configured such that repulsive force which is force to be restored into an unfolded state may be varied according to a temperature, and the driving circuit may be configured to apply power to at least one of the first alloy member and the second alloy member so that a sum of the repulsive force and the restoration force which are force by which the first alloy member or the second alloy member is restored is a predetermined value.

In addition, the thickness of the first alloy member and the thickness of the second alloy member may be configured to be different from each other.

In addition, the first alloy member may be configured to memorize a shape of the first alloy member in an unfolded state of the electronic device, and the second alloy member may be configured to memorize a shape of the second alloy member in a folded state of the electronic device.

In addition, the electronic device may further include a flexible carrier (e.g., the flexible carrier 580 of FIG. 9) made of a flexible, insulating, and adiabatic material, to accommodate the first alloy member and the second alloy member.

In addition, the electronic device may further include a heat dissipation member (e.g., the heat dissipation member 1500 of FIG. 15A) disposed adjacent to at least one of the first alloy member and the second alloy member.

In addition, at least one of the first alloy member and the second alloy member may be disposed to be in contact with the heating component of the electronic device.

A method of controlling an electronic device (e.g., the electronic device 101 of FIG. 1, the electronic device 200 of FIG. 2A, the electronic device 400 of FIG. 4) according to various example embodiments may include identifying, by at least one processor (e.g., the processor 120 of FIG. 1), separation of a first magnet (e.g., the first magnet 1710 of FIG. 17) of a first housing (e.g., the first housing 421 of FIG. 4) and a second magnet (e.g., the second magnet 1720 of FIG. 17) disposed in a second housing (e.g., the second housing 422 of FIG. 4) foldably connected, directly or indirectly, to the first housing detected using at least a hall sensor or a motion sensor, controlling, by the at least one processor, a driving circuit (e.g., the driving circuit 1410 of FIG. 14), such that at least a part thereof is fixed, directly or indirectly, to the first housing and the second housing and power is applied to an alloy member (e.g., the alloy member 500 of FIG. 12) made of a shape memory alloy material restored into a predetermined shape, based on the identification, identifying, by the at least one processor, a folded state of the first housing and the second housing detected using at least a folding sensor, and controlling, by the at least one processor, a driving circuit such that the power application to the alloy member is stopped, based on arrival of the folded state at a predetermined state.

In addition, the controlling of the driving circuit such that power is applied to the alloy member may include identifying, by at least one processor, a temperature value measured by a temperature sensor (e.g., the temperature sensor 1700 of FIG. 17) disposed adjacent to the alloy member, and controlling, by at least one processor, the driving circuit so that an amount of power applied to the alloy member is controlled, based on the identified temperature value.

In addition, the plurality of the alloy members may be provided and disposed symmetrically to each other with reference to the center of the electronic device.

In addition, the plurality of the alloy members may include the alloy member having the different thickness.

In addition, the plurality of the alloy members may include the first alloy member restored at the first temperature and the second alloy member restored at the second temperature higher than the first temperature.

In addition, the controlling of the driving circuit such that an amount of power applied to at least one of the first alloy member and the second alloy member is controlled may include controlling, by the at least one processor, the driving circuit such that power of the first temperature is applied to the first alloy member or power of the second temperature is applied to the second alloy member, based on the identified temperature value.

In addition, the controlling of the driving circuit such that power is applied to the alloy member may include identifying, by the at least one processor, a temperature value measured by a temperature sensor disposed adjacent to the alloy member, and controlling, by the at least one processor, the driving circuit such that an amount of power applied to at least one of the first alloy member and the second alloy member is controlled, based on the identified temperature value. “Based on” as used herein covers based at least on.

An electronic device (e.g., the electronic device 101 of FIG. 1, the electronic device 200 of FIG. 2A, the electronic device 400 of FIG. 4) according to various example embodiments may include a first housing (e.g., the first housing 421 of FIG. 4), a second housing (e.g., the second housing 422 of FIG. 4), a hinge device (e.g., the hinge device 431 of FIG. 5A) configured to connect the first housing and the second housing such that the electronic device is switched from a folded state into an unfolded state, an alloy member (e.g., the alloy member 500 of FIG. 12), at least apart of which is fixed, directly or indirectly, to the first housing, the second housing, and the hinge device and which is made of a shape memory alloy material, and a driving circuit (e.g., the driving circuit 1410 of FIG. 14) configured to apply power to the alloy member so that the alloy member is restored.

Embodiments disclosed in this specification and drawings merely present specific examples in order to easily describe the technical features according to the embodiments and to help understanding of the embodiments, and are not intended to limit the scope of the embodiments. Accordingly, the scope of the various embodiments of the disclosure should be construed in such a manner that, in addition to the embodiments disclosed herein, all changes or modifications derived from the technical idea of the various embodiments of the disclosure are included in the scope of the various embodiments of the disclosure. While the disclosure has been illustrated and described with reference to various embodiments, it will be understood that the various embodiments are intended to be illustrative, not limiting. It will further be understood by those skilled in the art that various changes in form and detail may be made without departing from the true spirit and full scope of the disclosure, including the appended claims and their equivalents. It will also be understood that any of the embodiment(s) described herein may be used in conjunction with any other embodiment(s) described herein.

1. An electronic device comprising:
a first housing;
a second housing;
a hinge device configured to connect the first housing and the second housing such that the electronic device can be switched from a folded state into an unfolded state;
a first alloy member, at least a part of which is fixed to the first housing, the second housing, and the hinge device and which comprises shape memory alloy material;
a second alloy member, at least a part of which is fixed to the first housing and the second housing at a position different from the first alloy member and which comprises shape memory alloy material; and
a driving circuit configured to apply power to at least one of the first alloy member and the second alloy member so that at least one of the first alloy member and the second alloy member can be restored.

2. The electronic device of claim 1, further comprising a temperature sensor disposed adjacent to the first alloy member and the second alloy member,
wherein the driving circuit is configured to control an amount of power applied to at least one of the first alloy member and the second alloy member, based on a temperature measured by the temperature sensor.

3. The electronic device of claim 1, further comprising a folding sensor configured to sense a folded state of the electronic device,
wherein the driving circuit is configured to control an amount of power applied to at least one of the first alloy member and the second alloy member, based on the folded state sensed by the folding sensor.

4. The electronic device of claim 1, further comprising a temperature sensor disposed adjacent to the first alloy member and the second alloy member,
wherein the first alloy member is configured to be restored at a first temperature,
the second alloy member is configured to be restored at a second temperature which is higher than the first temperature, and
the driving circuit is configured to apply power such that the first alloy member reaches the first temperature and/or to apply power such that the second alloy member reaches the second temperature, based on a temperature measured by the temperature sensor.

5. The electronic device of claim 1, wherein the first alloy member and the second alloy member are disposed symmetrically to each other with reference to a center of the electronic device.

6. The electronic device of claim 1, wherein a plurality of the first alloy members are provided to be disposed symmetrically to each other with reference to a center of the electronic device, and
a plurality of the second alloy members are provided to be disposed symmetrically to each other with reference to the center of the electronic device.

7. The electronic device of claim 1, further comprising a flexible display module comprising a flexible display, at least a part of which is disposed in the first housing and the second housing and which is configured to be foldable,
wherein the flexible display module is configured such that repulsive force which is force to be restored into an unfolded state varies according to a temperature, and
the driving circuit is configured to apply power to at least one of the first alloy member and the second alloy member such that a sum of the repulsive force and restoration force which are force by which the first alloy member and/or the second alloy member is restored is a predetermined value.

8. The electronic device of claim 1, wherein a thickness of the first alloy member and a thickness of the second alloy member are different from each other.

9. The electronic device of claim 1, wherein the first alloy member is configured to memorize a shape of the first alloy member in an unfolded state of the electronic device, and
the second alloy member is configured to memorize a shape of the second alloy member in a folded state of the electronic device.

10. The electronic device of claim 1, further comprising a flexible carrier comprising a flexible, insulating, and adiabatic material, to accommodate the first alloy member and the second alloy member.

11. The electronic device of claim 1, further comprising a heat dissipation member, comprising conductive material, disposed adjacent to at least one of the first alloy member and the second alloy member.

12. A method of controlling an electronic device, the method comprising:
identifying, by at least one processor, separation of a first magnet in a first housing and a second magnet disposed in a second housing foldably connected to the first housing detected using at least a hall sensor or a motion sensor;
controlling, based on the identification by the at least one processor, a driving circuit to apply power to an alloy member, at least a part of which is fixed to the first housing and the second housing and which comprises shape memory alloy material and is restored into a predetermined shape;
identifying, by the at least one processor, a folded state of the first housing and the second housing detected using at least a folding sensor; and
controlling, by the at least one processor, the driving circuit to stop application of the power to the alloy member, based on arrival of the identified folded state at a predetermined state.

13. The method of claim 12, wherein the controlling of the driving circuit to apply power to the alloy member comprises:
identifying, by at least one processor, a temperature value measured by a temperature sensor disposed adjacent to the alloy member; and
controlling, by at least one processor, the driving circuit to control an amount of power applied to the alloy member, based on the identified temperature value.

14. The method of claim 13, wherein alloy member comprises a plurality of alloy members including a first alloy member restored at a first temperature and a second alloy member restored at a second temperature higher than the first temperature, and
wherein the controlling of the driving circuit to control the amount of power applied to at least one of the first alloy member and the second alloy member comprises controlling the driving circuit by the at least one processor to apply power of the first temperature to the first alloy member and/or to apply power of the second temperature to the second alloy member, based on the identified temperature value.

15. The method of claim 12, wherein the controlling of the driving circuit to apply power to the alloy member comprises:
identifying, by the at least one processor, a temperature measured by a temperature sensor disposed adjacent to the alloy member; and
controlling the driving circuit by the at least one processor to control the amount of power applied to at least one of a first alloy member and a second alloy member, based on the identified temperature.
